(19) United States
(12) Patent Application Publication
(10) Pub. No.: US 2005/0015333 A1
(43) Pub. Date: Jan. 20, 2005

(54) Sales management

(76) Inventors: Sven Schwerin-Wenzel, Dielheim (DE); Eric Wood, Menlo Oaks, CA (US); Nir Kol, Sunnyvale, CA (US); Dennis B. Moore, Hillsborough, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/768,402

(22) Filed: Jan. 30, 2004

Related U.S. Application Data
(60) Provisional application No. 60/455,087, filed on Mar. 14, 2003.

(51) Int. Cl. G06F 17/60

(52) U.S. Cl. 705/39

(57) ABSTRACT

Systems and techniques relating to software for enterprise change, in particular to merger and acquisition processes and tools for one or more organizations. A method includes providing a single logical physically distributed information system across one or more information systems of at least two enterprises, wherein the enterprises are being combined, and providing a user interface to access the single logical physically distributed information system to execute one or more merger activities of the enterprises, the merger activities comprising a sales-related integration and a management of sales support activities, the sales support activities comprising addressing one or more customer issues for customer retention.

### CROSS REFERENCE TO RELATED APPLICATIONS

This application claims priority to U.S. Provisional Application entitled “ENTERPRISE CHANGE PLANNING AND EXECUTION,” filed on Mar. 14, 2003, Application Ser. No. 60/455,087.

### BACKGROUND

During an organizational restructuring, such as a merger or acquisition, an organization needs to determine how to effectively serve current customers. In order to obtain one or more restructuring goals, organizations desire to share customer information and resources to reduce the risk of unwanted redundant customer services and support. Moreover, organizations want to ensure that customer concerns and sales-related issues are addressed in the restructuring process.

### SUMMARY

The present application describes systems, methods and software for enterprise change as a result of restructuring, such as mergers & acquisitions (M&As), for one or more organizations.

In an aspect, the invention features a method including providing a single logical physically distributed information system across one or more information systems of at least two enterprises, wherein the enterprises are being combined, and providing a user interface to access the single logical physically distributed information system to execute one or more merger activities of the enterprises, the merger activities including a sales-related integration and a management of sales support activities, the sales support activities including addressing one or more customer issues for customer retention.

In embodiments, the merger activities further can include customer-related communications, the user interface allowing a user to access the single logical physically distributed information system to execute at least one of pre-merger and post-merger activities, wherein the post-merger activities can include a post-merger assessment and a measurement of one or more achieved synergies. The user interface can be adapted to the role of the user and a phase of the merger, a security of the user interface is related to the role of the user, the role of the user including an executive of one or more sales-related accounts.

In another aspect, the invention features a method including providing a user interface adapted to manage one or more cross-selling opportunities for at least one organization involved in a merger with another organization, and allowing a user to edit one or more cross-selling opportunities presented in the user interface.

In embodiments, the method can include providing information for at least one of the cross-selling opportunities in the user interface, the information including financial information, providing a notification template in the user interface, and providing a trigger date in the user interface.

In another aspect, the invention features a system for managing a merger of at least two organizations including a module and a graphical user interface adapted to assist retention of one or more customers of at least one of the organizations.

In embodiments, the system further includes a first tool adapted to provide predefined templates for customer-related objects, wherein the customer-related objects can include customer documents and electronic mailings. The system can also include a second tool adapted to track one or more customer reactions to merger developments, the merger developments including merger-related news and merger-related announcements. The system can include a third tool adapted to assist in at least one of an assignment, a mapping, and a transfer of one or more customer accounts, the one or more customer accounts including sales-related accounts.

The third tool can be adapted to facilitate a performance comparison of at least two customer-related personnel for at least one of the merger organizations, the two customer-related personnel including two account executives.

In another aspect, the invention features a method for managing a merger of at least two organizations including providing a module adapted to proactively identify and present on a user interface a sales counterpart in a first merger organization related to a member of a second merger organization.

In embodiments, the method can include producing an electronic mailing, the production of the electronic mailing including importing lists of data, the lists including a customer list and a customer assignment list, consolidating the lists of data, the consolidating including syntactic mapping of one or more character fields, configuring an electronic mailing content, and screening the electronic mailing content, the content including one or more accounts.

The method can include delivering the electronic mailing content to a sales-related merger member, and providing an exception workflow for undeliverable electronic mailings.

In another aspect, the invention features a system for planning a merger of at least two organizations, the system including an interface presenting financial information for one or more sales-related and customer-related initiatives of at least one organization, the financial information presented in a list or graph.

In another aspect, the invention features a system including sales-related interfaces for a merger of at least two organizations, user interface components adapted to interact with sales-related interfaces, and a layer of application logic services, the layer interacting with sales-related interfaces, and the application logic services relating to the merger.

Details of one or more implementations are set forth in the accompanying drawings and the description below. Other features and advantages can be apparent from the description, drawings, and claims.

### BRIEF DESCRIPTION OF THE DRAWINGS

These and other aspects will now be described in detail with reference to the following drawings.

FIG. 1 is a block diagram of a system.

FIG. 2 is a flow diagram.

FIG. 3 is block diagram of an architecture.

FIG. 4 is block diagram of a platform.

FIGS. 5-26 illustrate exemplary user interfaces.

Like reference symbols in the various drawings indicate like elements.

### DETAILED DESCRIPTION

The systems and techniques described here relate to software for organizations in a restructuring environment, such as a merger and acquisition (M&A). In particular, the system and methods described herein can aid in an integration and implementation of customer-related and sales-related information and resources for one or more restructuring organizations.

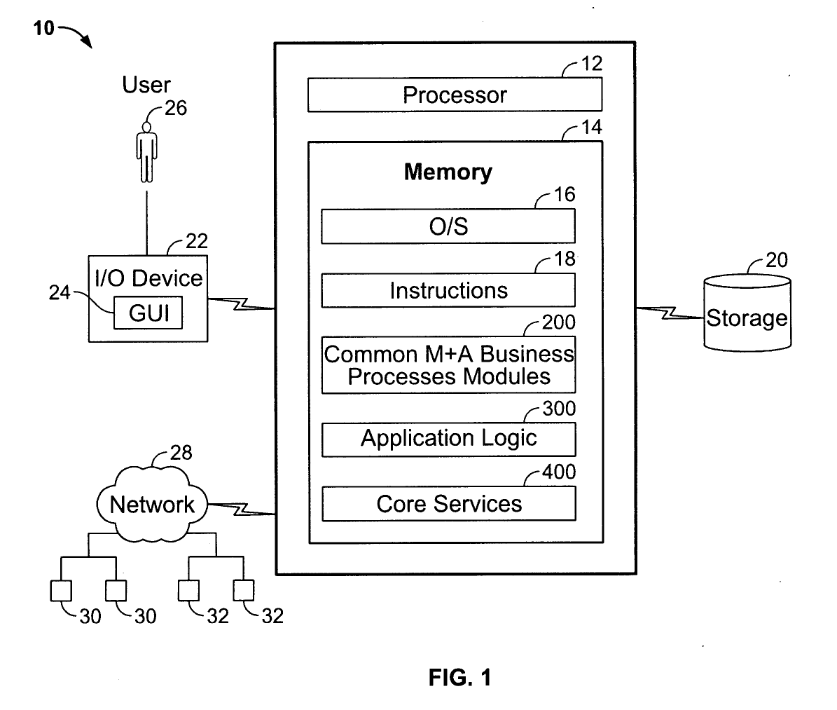

As shown in FIG. 1, a system 10 includes a processor 12 and a memory 14. Memory 14 includes an operating system 16, and instructions 18, that when executed by the processor 12, perform an exemplary restructuring integration process 100, described below. A specific restructuring process, referred to as a merger and acquisition (M&A), will be used as an example throughout this description. However, the process 100 can be applied to most corporate change or restructuring activities, such as spin-offs, department mergers and splits, and so forth. Memory 14 also includes common restructuring business processes modules 200, application logic 300, and a core framework of services 400 that support the restructuring integration process 100. The system 10 includes a link to a storage device 20 and an input/output device 22. The input/output device 22 can include a graphical user interface (GUI) 24 for display to a user 26.

The system 10 includes a link to a network 28. Network 28 links the system 10 to other systems 30 within a single entity and to systems 32 in one or more other entities. Systems 30, 32, generally referred to as clients or source systems, access data through a portal 34. Systems 10, 30, 32 are designed to act as a single logical physically distributed information system representing multiple enterprise information systems of organizations residing in the systems 30, 32. Information is exchanged between the system 10 and systems 30, 32 through the portal 34 and through user interfaces (UIs) of an architecture, described below.

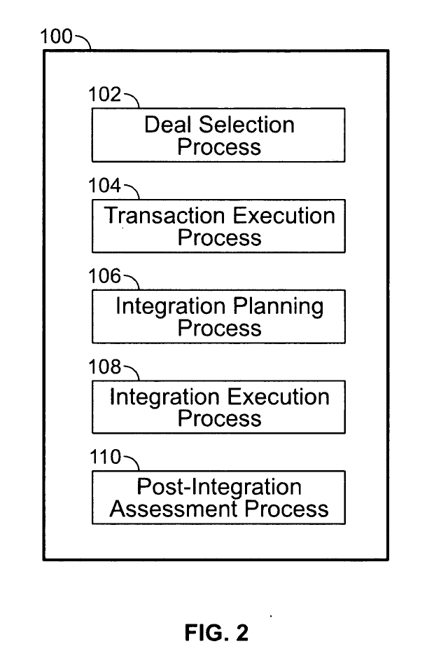

As shown in FIG. 2, the restructuring integration process 100 includes a deal selection process 102. The deal selection process 102 defines acquisition objectives and strategies. The deal selection process 102 searches for the best fit target company to meet a set of objectives and manages detailed due diligence on the target company. The deal selection process 102 also identifies synergies, risks and a realization plan for acquiring the target company.

A transaction execution process 104 structures an acquisition in terms of type, tax implications, legal issues and so forth. The transaction execution process 104 closes an acquisition deal and provides for a rollback in the event the acquisition deal fails.

An integration planning process 106 provides a plan for short term and long term tasks of acquisition integration and communicates goals and decisions to all stakeholders.

The restructuring integration process 100 includes an integration execution process 108. The integration execution process 108 manages an integration project and it sub-projects, designs a new organization, and minimizes disruptions to customers by rolling out combined field organizations quickly. The integration execution process 108 manages the integration of information technology (IT), human resources (HR), financials and procurement. The integration execution process 108 provides for the retention of key employees, manages field organization integration, and identifies cross-selling opportunities and rolls the opportunities out. The integration execution process 108 manages stakeholders, tracks an acquisition, and reports issues and successes.

The restructuring integration process 100 includes a post-integration assessment process 110. The post-integration assessment process 110 measures achieved synergies against targets, accesses where improvements can be made in synergy estimation and/or in integration execution, and applies history to a next transaction.

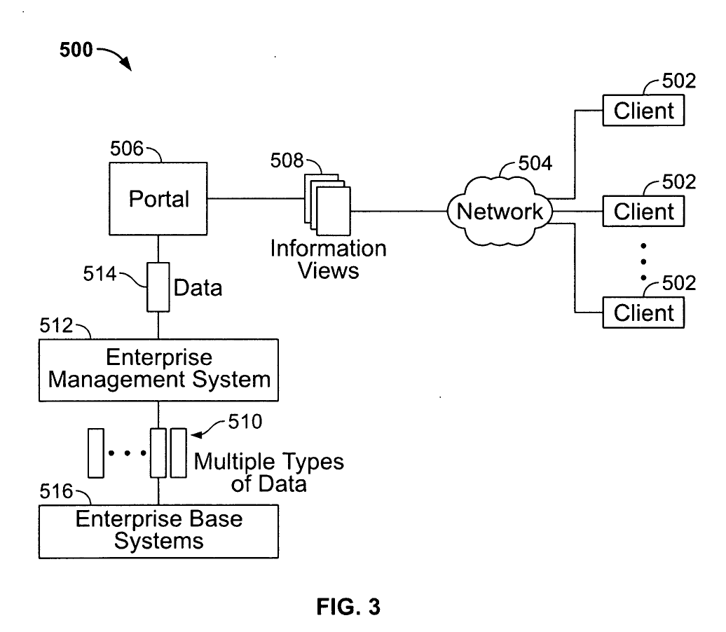

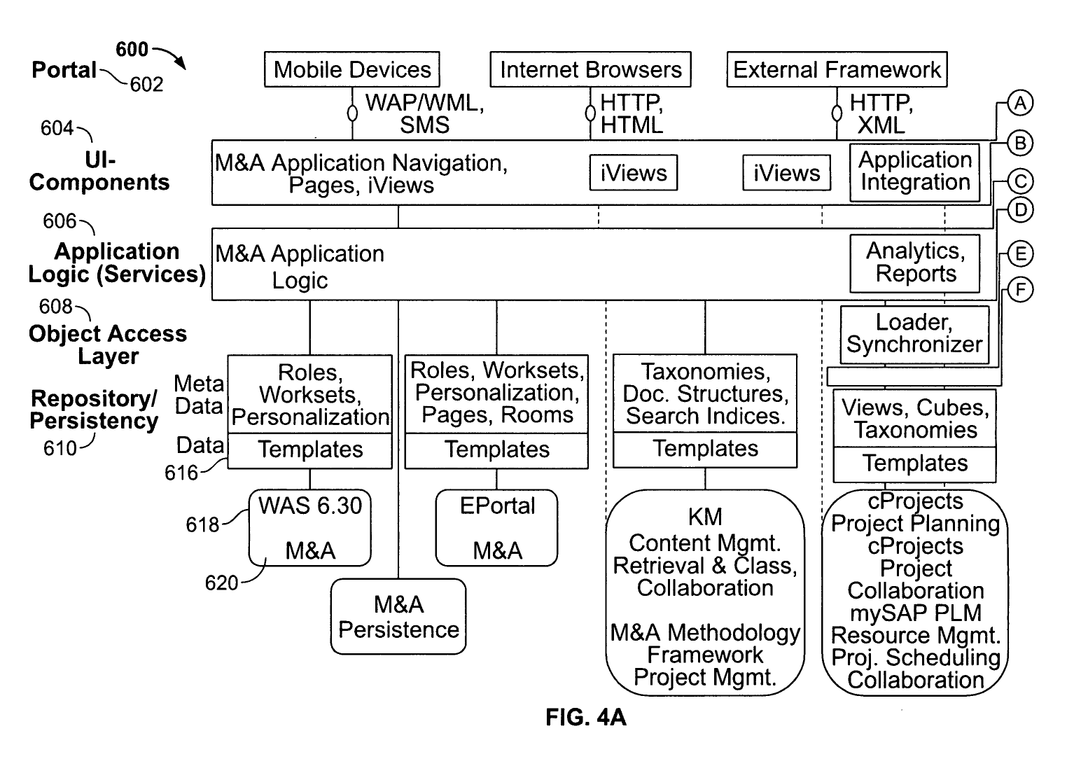

As shown in FIG. 3, the restructuring integration process 100, common restructuring business processes modules 200, application logic 300, and core framework of services 400 are designed to conform to an architecture 500 designed to a platform 600 that represents a single logical physically distributed information system representing multiple enterprise information systems of organizations. The architecture 500/platform 600 insure consistency of data exchange between system 10 and source systems 30, 32, and a separation of source systems 30, 32, when appropriate during phases of the restructuring integration process 100.

The single logical physically distributed information system architecture 500 representing multiple enterprise information systems of organizations includes multiple clients 502 accessing data over a network 504 through a portal 506. In one embodiment, the clients 502 are processes and/or web browsers that are coupled to the network 504 through a proxy server (not shown).

The portal 506 provides a common interface to program management services through user interface (UI) components 508. The portal 506 receives requests from the clients 502 and generates information views (iViews) 510, such as web pages, in response. In embodiments, the portal 506 implements a user roles-based system to personalize a common interface and the iViews 510 for a user of one of the clients 502. The user can have one or more associated roles that allow personalized tailoring of a presented interface through the iViews 510.

The portal 506 communicates with an enterprise management system 512 that consolidates multiple application services.

The portal 506 receives data 514 from the system 512 to fulfill the requests of the clients 502. The system 512 provides integrated application services to manage business objects and processes in a business enterprise. The business objects and processes include resources such as personnel, development projects, business programs, inventories, clients, accounts, business products, business services and so forth.

The system 512 communicates with enterprise base systems 516 to obtain multiple types of enterprise base system data 518. The base systems 516 include application services, such as human resource management systems, customer relationship management services, financial management systems, project management systems, knowledge management systems, business warehouse systems, time management systems, electronic file systems and mail systems. In embodiments, the enterprise base systems 516 include a single integration tool, such as exchange from SAP AG of Germany, which provides an additional level of integration among the enterprise base systems 516. The enterprise management system 512 consolidates and integrates data and functionality of the enterprise base systems 516 into the single management tool.

The single management tool includes systems and methods to facilitate generation of new applications within the enterprise management system 512. The new applications, generally referred to as cross-functional or composite applications, draw on resources of the enterprise base systems 516 to cross over traditional application boundaries and handle new business scenarios in a flexible and dynamic manner.

A virtual business cycle can be generated using such composite applications, where executive level business strategy can feed management level operational planning, which in turn can feed employee level execution, which can feed management level evaluation, which can feed executive level enterprise strategy. Information generated in each of these stages in an enterprise management cycle can be consolidated and presented by the enterprise management system 512 using the customized cross-functional applications. The stages provide and consume determined services that are integrated across multiple disparate platforms.

The portal 506, enterprise management system 512 and enterprise base systems 516 can reside on one or more programmable machines, which communicate over the network 504 or one or more communication busses. In embodiments, the base systems 516 reside in multiple servers connected to the network 504, and the portal 506 and enterprise management system 512 reside in a server connected to a public network (not shown). Thus, the architecture 500 can include customized, web-based, cross-functional applications, and a user can access and manage enterprise programs and resources using these customized web-based, cross-functional applications from anywhere that access to the public network is available.

A user interface (UI) provides UI patterns used to link new objects and workflow together and generate standardized views into results generated by one or more cross-functional applications.

An object modeling tool enables generation of new business objects in a persistency/repository layer by providing a mechanism to extend a data object model dynamically according to the needs of an enterprise.

A process modeling tool enables generation of new business workflow and ad hoc collaborative workflow. The process modeling tool includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure is trackable by a process owner or by involved contributors using a “dashboard” that displays highly aggregated data. The dashboard and a “myOngoingWork place” can be two UI patterns that are provided by the UI components 508.

Whenever there is a concept of “myObjects,” “myRecentObjects,” “myRelatedObjects” or “myPreferredObjects,” then an object picker UI pattern, provided by the UI components 508, is included that lets users pick their favorite object directly. Whenever people are to be searched, either for choosing one individual person or for generating a collection of people meeting some criterion, a “People Finder” concept can be applied. A key aspect of searching for a person is described as an attribute within the user's activity, qualification, interest, and collaboration profile. For a given cross-functional application, people collections can be stored as personal or shared collections using the People Finder to make them available for further operations later on.

Whenever there is a strategic view on a cross-functional application scenario, analytics of the overall portfolio can be made available in the form of a collection of the UI components 508. A view selector is used to display/hide components, and a component can be toggled between graphical and numerical display and include a drop-down list or menu to select sub-categories or different views.

Cross-functional application scenarios provide related information to the user when possible, and some parts within a larger cross-functional application define what kind of related information is to be offered. Heuristics can be used to identify such relatedness, such as follows: (1) information that is related to the user due to explicit collaborative relationships, such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set); (5) instances of the same object class; (6) next abstract or next detailed class; (7) explicit relationships on the organizational or project structure; (8) proximity on the time scale; (9) information about the underlying business context; and/or (10) information about the people involved in a collaborative process.

Cross-functional applications also can include generic functionality in the form of “Control Center Pages” that represent generic personal resources for each user. These cross-functional applications can refer to the following pages, where appropriate: (1) A “MyOngoingWork” page that provides instant access to all dashboards that let users track their ongoing work. Ongoing work refers to the state of business objects as well as guided procedures. (2) A “MyDay” page that lists today's time based events that are assigned or related to the user. (3) “MyMessageCenter” page that displays all pushed messages and work triggers using a universal inbox paradigm with user selected categorical filters. (4) “MyInfo” that provides access to all personal information collections (documents, business objects, contacts) including those located in shared folders of teams and communities of which the user is a member. MyInfo can also provide targeted search in collaborative information spaces such as team rooms, department home pages, project resource pages, community sites, and/or personal guru pages.

The object modeling tool, process modeling tool and user interfaces are used to build components of cross-functional applications to implement new enterprise management functions without requiring detail coding development by a system architect or programmer.

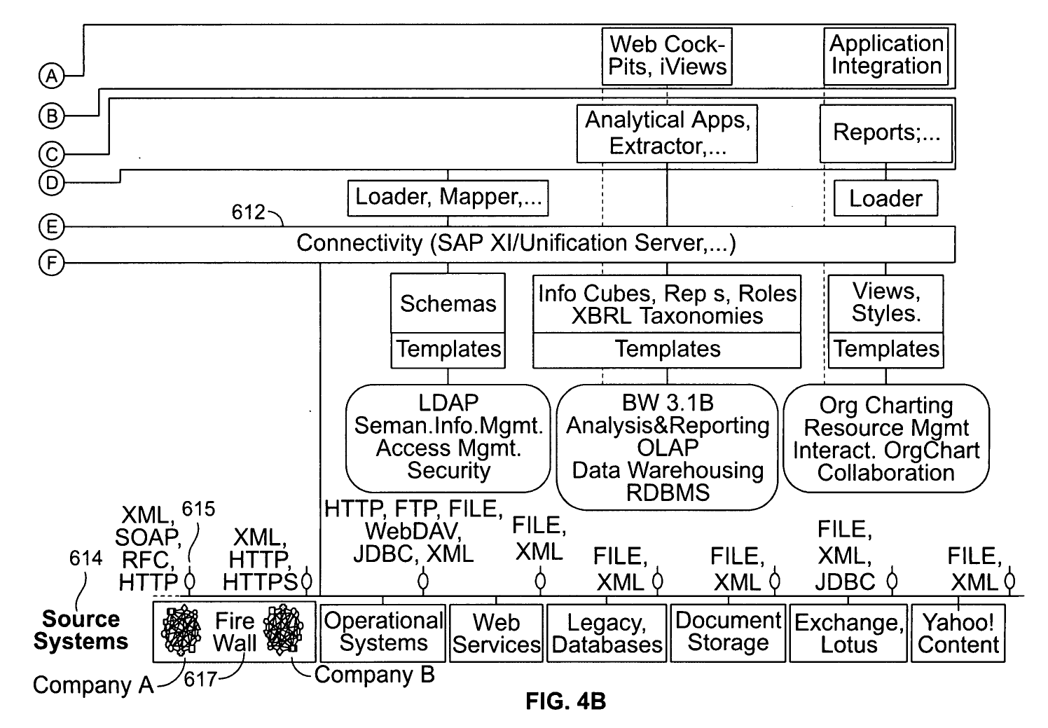

As shown in FIG. 4, a platform 600 that supports the architecture 500 includes a portal 602, user interface (UI) components 604 and application services logic 606. The platform 600 includes an object access layer 608, a persistence/repository layer 610, connectivity layer 612, and source systems 614. In embodiments, the architecture includes software and components from SAP AG of Germany, as well as special corporate restructuring modules.

Graphical user interfaces (GUIs) provide interaction between a user and the UI components 604 through the portal 602. The UI components 604 interact with the application services logic 606. The application services logic 606 interact with databases and repositories in the persistence/repository layer 610. The user requests information via a GUI through the portal 602. The application services logic 606 processes the user request, retrieves the appropriate requested information from the databases and repositories in the persistence/repository layer 610, and sends the requested information to GUI for display to the user.

The databases and repositories in the persistence/repository layer 610 can contain metadata. Metadata refers to data that describes other data, such as data pertaining to roles, work sets and personalization information, for example. The metadata can interact with the object access layer 608, connectivity layer 612 and application services logic 606. The metadata can also interact with templates 616. The templates 616 provide a format or organization of information according to preset conditions. The templates 616 can interface with Web application server (WAS) processes 618 and core merger processes 620 in the repository layer 610.

In embodiments, the databases and repositories in the persistence/repository layer 610 interact with the source systems 614 through base system connectors 615 using a markup language such as extensible markup language (XML), web services such as Simple Object Access Protocol (SOAP), request for comments (RPC), or Transmission Control Protocol/Internet Protocol (TCP/IP). The source systems of one organization can interact with the source systems of another organization through a firewall 617.

The base system connectors 615 can include a enterprise connector (BC) interface, Internet communication manager/Internet communications framework (ICM/ICF), an encapsulated postscript (EPS) interface and/or other interfaces that provide remote function call (RFC) capability.

The persistence/repository layer 610 provides the platform 600 with its own database and data object model. The database and data object model provides a consolidated knowledge base to support multiple enterprise functions, including functions generated as cross-applications. Active communication between the persistence/repository layer 610 and the base systems 516/614 provides a linkage between real time relational data from multiple base systems 516/614 and an integrated enterprise tool to permit strategic enterprise management and planning.

The data object model represents a subset of data objects managed by base systems 516/614. Not all of the data aspects tracked in the base systems 516/614 need to be recorded in the data object model. The data object model has defined relationships with data objects stored in the base systems 516/614. For example, certain data objects in the data object model have “read-only” or “write-only” relationships with data objects in the base systems 516/614. These types of defined relationships are enforced through a communication process between the persistence/repository layer 610 and the base systems 516/614. The persistence/repository layer 610 decouples application development from the underlying base systems 516/614.

In embodiments, the source systems 516/614 interact with third party applications, such as Lotus software from IBM or data provided by other content providers, such as Yahoo! As described above, the portal 602 provides a common interface to management services. The management services include a merger project management service and a merger integration project management service. The network 504 links the clients 502 to the portal 602 for exchange of information pertaining to a merger of two organization organizations or an acquisition involving two organizations.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

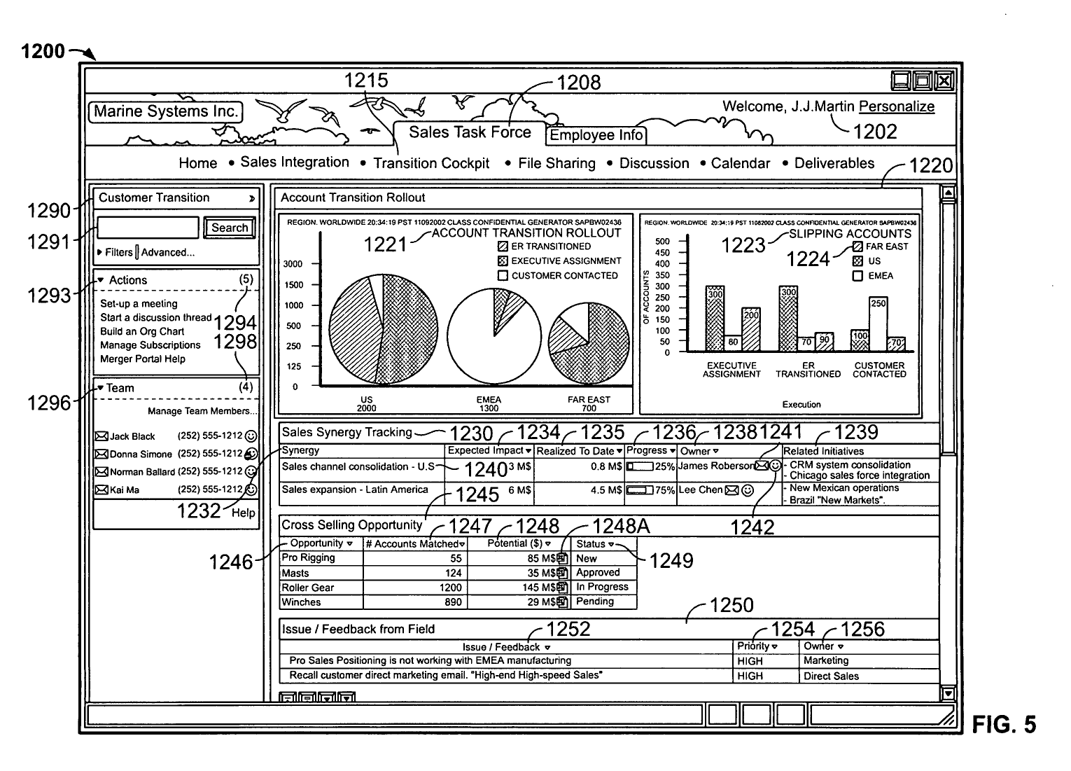

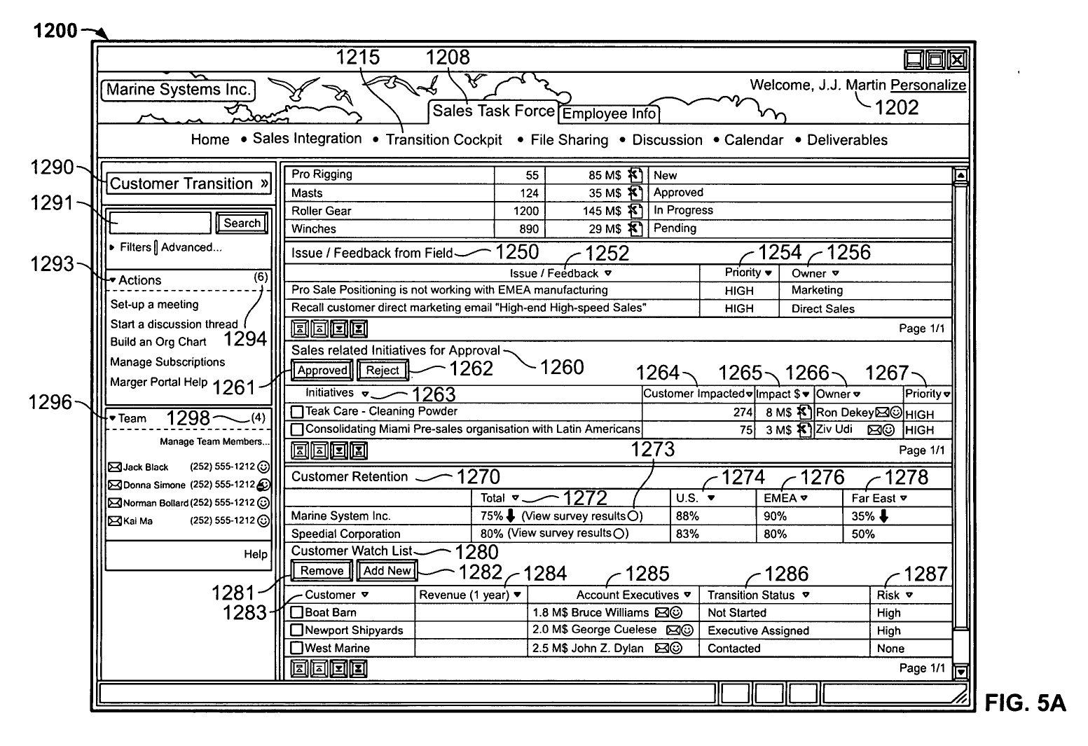

FIG. 5 shows an example of a tool interface 1200 for a stakeholder 1202 with access to a sales task force menu 1208. Other possible personalized views for stakeholders in the sales task force interface 1200 include views for sales integration, file sharing, discussions, deliverables, and a calendar. The view presented in interface 1200 is a transition cockpit view 1215. The view 1215 allows the stakeholder 1202 to access and manage sales-related transition tools for the merger, including an account transition rollout 1220 and sales synergy tracking 1230. The account transition rollout 1220 presents graphs 1221 and charts 1223 of accounting information, including regional or divisional account information 1224 and accounts 1223 that are slipping from schedule.

Interface 1200 further presents a panel 1245 to allow a user 1202 to view and analyze one or more user-identified cross selling opportunities. One or more stakeholders can identify one or more cross-selling opportunities 1246 and the disclosed software can expedite and help ensure the rollout and monitoring of the execution of the opportunity. The panel 1245 can present one or more opportunities 1246 and a number of accounts matched 1247 for each opportunity. A status 1249 and a potential value 1248 of each opportunity can be evaluated and presented in a linked object 1248A.

The linked object 1248A can be an external software object, such as an Excel® spreadsheet by Microsoft Corporation.

FIG. 5 and FIG. 5A present an exemplary panel 1250 for issues or feedback 1252 from customers or other merger stakeholders. The feedback 1252 can arrive from stakeholders who sell or market products or services to customers and can include a corresponding priority level 1254. The feedback 1252 can provide the merger organizations with valuable information on marketing, selling, and advertising products and services. The feedback 1252 can also allow a merger organization to identify strengths and weaknesses in organizational products, services, strategy, personnel, and goals during the merger process. Moreover, the feedback 1252 can allow merger organizations to track customer reactions to merger developments and announcements.

FIG. 5A further presents a panel 1260 for sales-related initiatives for approval from a stakeholder. The panel 1260 presents buttons for approval 1261 and rejection 1262. The panel 1260 can present a checklist of initiatives 1263 with a number of impacted customers 1264, a financial impact 1265, an owner 1266 and a priority level 1267 for each initiative 1263. Sometimes, a merger organization can desire to assure customers that organizational changes will enhance customer service and customer relationships. Additionally, merger organizations can want to prevent rival organizations from securing customer accounts. The interface 1200 presents a panel 1270 for each merger organization with a measure of customer retention 1272. The panel 1270 presents one or more retention rates 1271 for a division or region 1274, 1276, 1278. Alternatively, the interface can present customer satisfaction rates 1271, including customer surveys 1273. The customer survey 1273 can be presented in an external object. Moreover, the panel 1270 can indicate if there has been any movement (via an arrow) 1279 of the rates 1271 (e.g., increasing or decreasing rates 1271). Furthermore, the interface 1200 can have a panel 1290 with a text box 1291 to allow the user 1202 to search for items or people, as well as to perform a number 1294 of other actions 1293. The user 1202 can also contact a number 1298 of merger team members 1296.

FIG. 6 presents an exemplary interface 1300 to allow a user 1202 to consolidate customer accounts 1315 from the sales task force menu 1208. The interface 1300 can present an account profile 1320 of a merger organization 1330 and sort a list 1333 of customer accounts 1332 based on one or more predefined parameters in a pull down menu 1323. The interface can help identify and match similar accounts 1332, 1343 from at least two merger organizations 1330, 1340. The interface 1300 presents a value 334 of each account 1332 for a number 1345 of accounts, and sort accounts 1332 by account values 1334.

Customer service personnel 1336, 1346 from each merger organization 1330, 1343 are presented, and an assignment 1347 made for the person responsible for the account. For instance, Joe Dylan 1338 from Speedial, Inc. 1330 and Allen Maxwell 1348 from Marine Systems 1340 have a cooperative assignment 1341 for a West Marine Inc. account 1339.

Alternatively, either executive 1336, 1346 from the merger organizations 1330, 1340 individually are assigned to be responsible for a customer account 1332. When the customer names 1337, 1342 do not completely match, the interface 1300 allows the user 1202 to manually select a customer from a list for exception listing. The user 1202 selects a link (e.g., icon 1344) to access the customer list.

The interface 1300 also presents a panel 1350 allowing a user 1202 to access one or more links to merger-related views, including an account assignment view 1355, an account executive (AE) management view 1360, and a profile management view 1365. Other linked views include a schedule rollout view 1370, a cross selling planning view 1375, a rollout management view 1380, and a view 1385 for monitoring the merger process. The panel 1350 allows a user to perform a search 1390, and perform a number 1392 of other merger-related actions 1395.

The panel 1300 also includes a tool to model a “clean room” environment 1317 during the merger process. The clean room concept during a merger typically involves members of the involved organizations physically meeting in a room and exchanging information and objects. Only the members of a clean room environment can view and examine confidential and privileged information of other merger organizations. If the merger deal is unsuccessful and fails, then the clean room members often leave their organization for reasons of conflicts of interest, or are transferred to other parts of their organization where they will not be interacting with the other merger organizations.

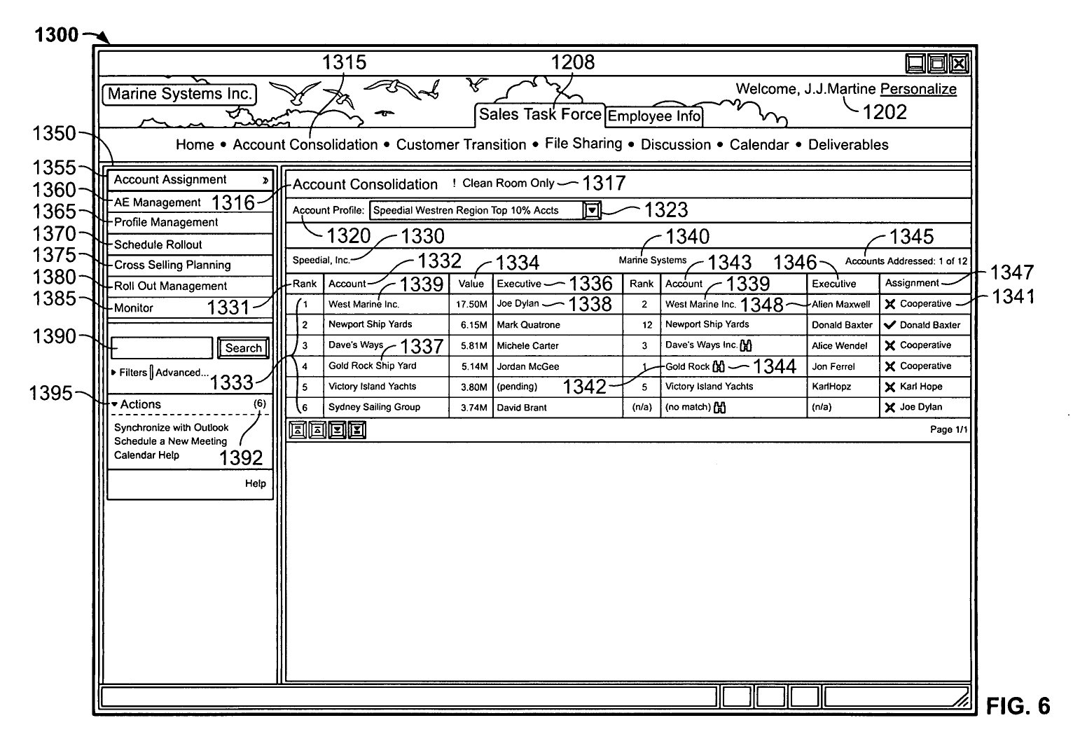

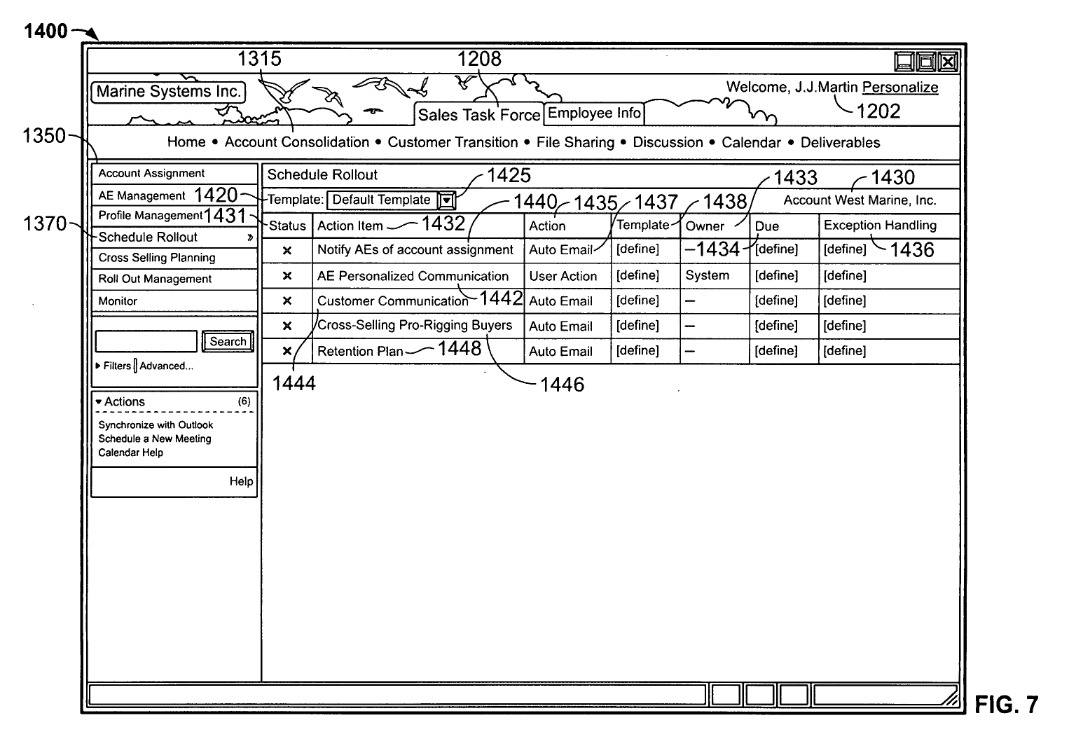

FIG. 7 presents an interface 1400 that allows a user 1202 to consolidate accounts 1315 in the sales task force menu 1208. The user 1202 selects to view a schedule rollout view via link 1370. The user 1202 also views a schedule rollout template 1420 from a template format in a pull down menu 1425. The user 1202 examines a status 1431 of an action item 1432. A status indicator 1431A (e.g., an “X” indicator) signifies that the action has not been completed. The user 1202 also performs an action 1435, such as automatically sending an email 1437 and defining a template 1438. Additionally, an owner 1433 and a due date 1434 of the action item 1432 can be presented. The interface 1400 also facilitates exception handling 1436 for the action items 1432. Some exemplary action items 1432 include notifying an account executive (AE) of an assignment 1440, facilitating AE personalized communication 1442, and conducting customer communication 1444. Other exemplary action items 1432 involve a cross-selling opportunity 1446 and a retention plan 1448.

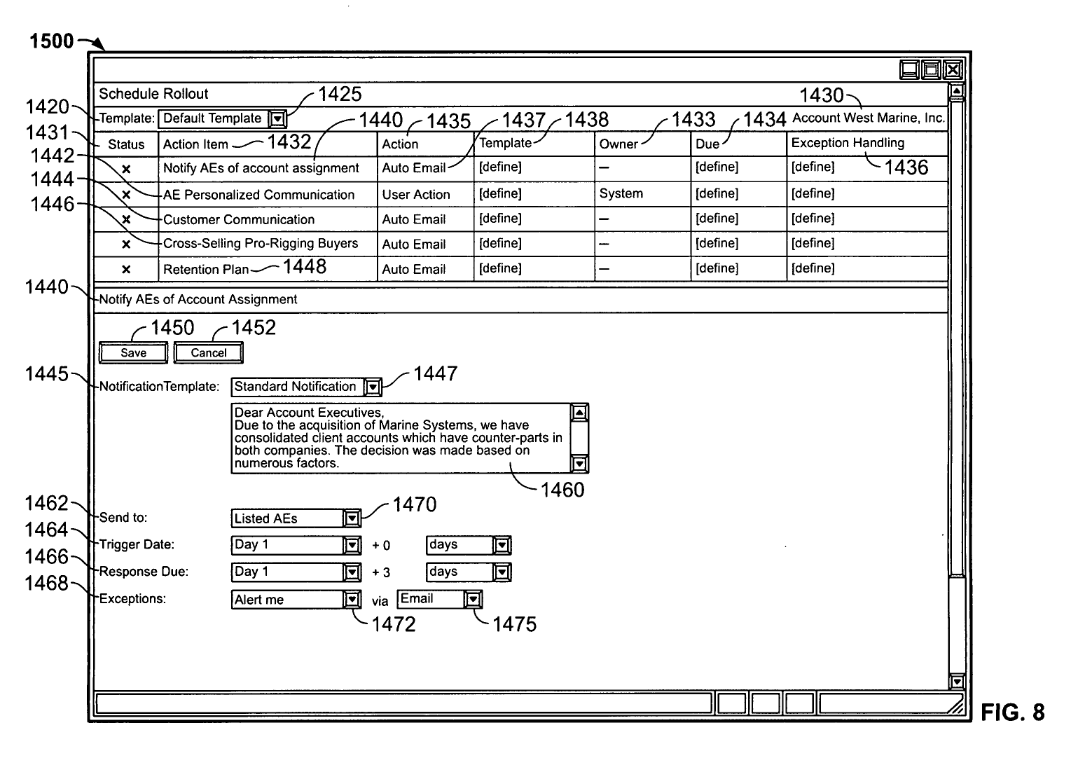

FIG. 8 presents an interface 1500 in which the user 1200 can select to notify an AE of an account assignment 1440. A notification template 1445 and a template format in a pull down window 1447 are presented. A message can be entered in a text box field 1460. The user 1202 can then send the assignment notification 1440 to one or more stakeholders shown in a pull down menu 1470. The notification 1440 includes a trigger date 1464 and a response date 1466. The interface 1500 also facilitates exceptions 1468 to the notification 1440, such as sending an alert email 1472, 1475.

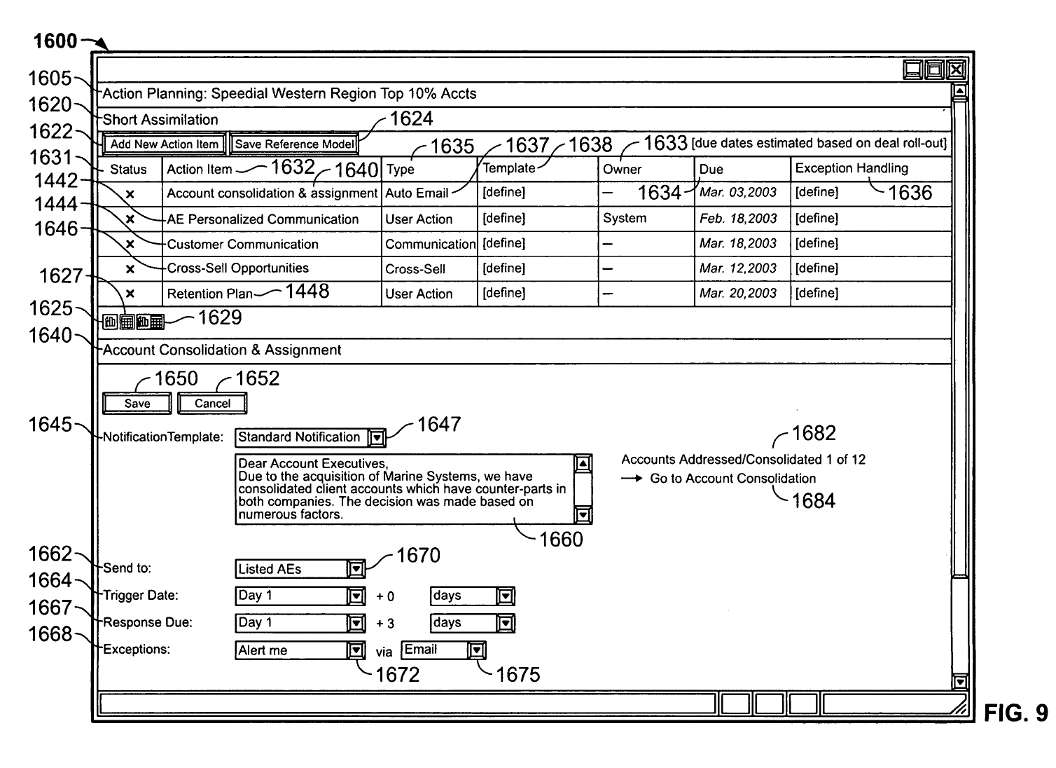

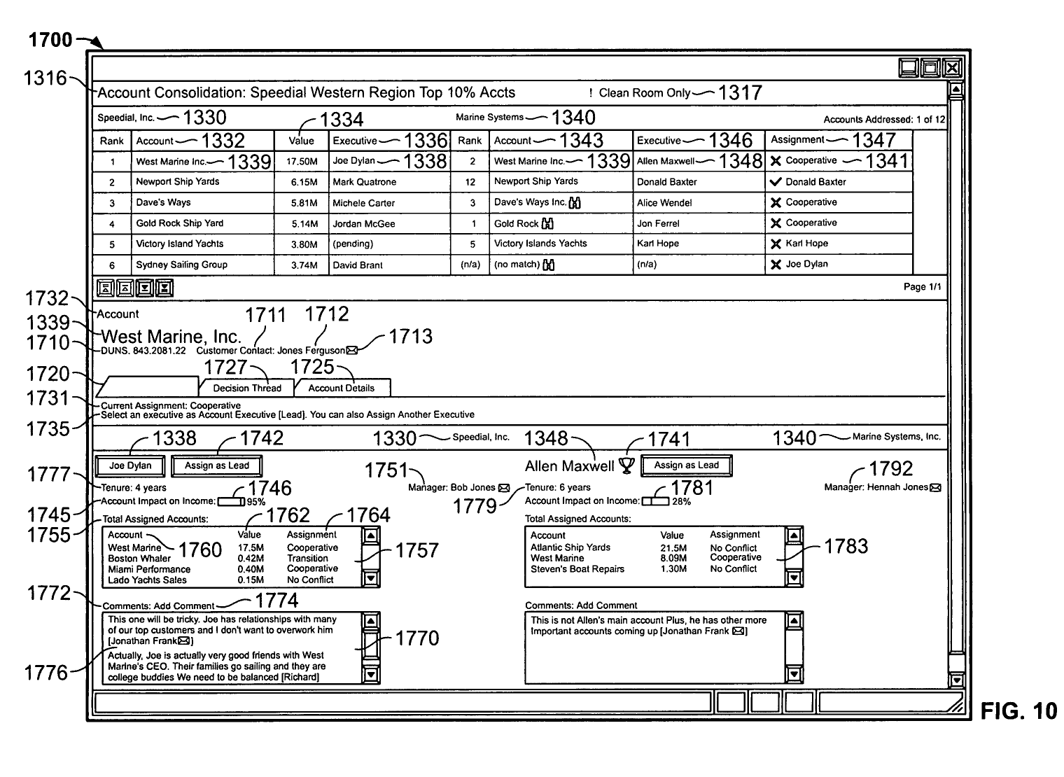

FIG. 9 presents an interface 1600 that facilitate action planning 1605 for one or more accounts. The interface 1600 includes a panel 1620 for an assimilation of action items 1632. The panel 1620 presents a status 1631 and an action type 1635 for each action item 1632 including, an action type 1635 for automatically sending an email 1637. The panel 1620 can also include a template 1638, an owner 1633, a deadline 1634, and an exception handler 1636. Some exemplary action items 1632 can include account consolidation and assignment 1640, AE personalized communication 1442, and customer communication 1444. Other action items 1632 includes cross selling opportunities 1646 and a retention plan 1448. The panel 1620 presents a graph 1625 of action items 1632, a list 1627 of action items 1632 or both a graph and a list of action items 1629.

FIG. 9 additionally presents a panel 1640 for account consolidation and assignment. The panel 1640 presents a notification template 1645 and a template format in a pull down window 1647. A message or description can be entered in a text box field 1660. Account notification can be sent to one or more stakeholders listed in a pull down menu 1670. The notification can include a trigger date 1664 and a response date 1667. The interface 1600 facilitates exceptions 1668, such as sending an alert email 1672, 1675. Furthermore, the interface 1600 presents a number 1682 of consolidated or addressed accounts, and presents a link 1684 to an account consolidation view.

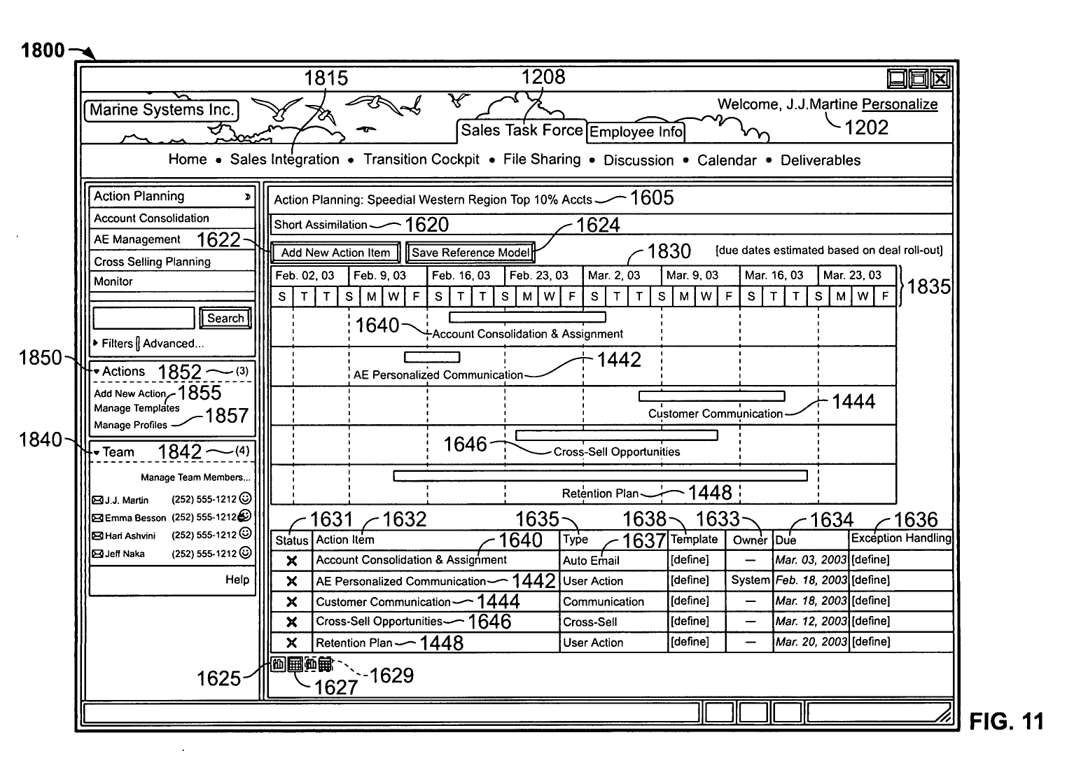

An account consolidation interface 1700 in FIG. 11 can be presented from the link 1684 in interface 1600 or from selecting an account 1332 in the account list 1333 in FIG. 7. Panel 1316 in interface 1700 presents similar account consolidation information as shown in the account list 1333. The user 1202 selects an account title 1339 to present additional account detail 1339 in another account panel 1732.

The panel 1732 shows the account 1339, an account identification number 1710, a customer contact name 1712, and an email link 1713 for the customer contact 1711. The account panel 1732 shows a tabbed menu for account assignments 1720, decision threads 1727, and other account details 1725. The decision thread 1727 presents a log of a collaborative decision process in which merger managers can exchange ideas and communications. The tab 1720 selected and presented in the interface 1700 is the account assignment tab 1720.

The interface 1700 presents a current assignment type 1731 and allows the user 1202 to select a lead person 1735 for the account 1339. The interface 1700 allows the user 1202 to examine and comparatively inspect account information for at least two of the merger organizations 1330, 1340. The interface 1700 shows one or more details for executives 1338, 1348 of the account 1339 for one or more merger organizations 1330, 1340. For example, interface 1700 can show a manager 1751, 1752 and a length of tenure 1777, 1779 for each account executive 1338, 1348. The interface 1700 can help identify if an account executive 1348 has a notable achievement 1741. A measurement 1746, 1781 for an impact the account 1339 has on income 1745 for each organization 1330, 1340.

System 10 allows the user 1202 to reduce a risk of having redundant personnel working on the same customer accounts. In addition to possibly consolidating customer accounts, system 10 allows a number of customer support personnel to be consolidated. Moreover, the system 10 allows user 1202 to determine and select the most capable personnel to manage certain customer accounts. For example, the user 1202 can choose to assign 1731, 1735 the account executive 1348 with the notable achievement 1741 to handle the account 1339. The presented information for account executive 1338, 1348 can also include a combination of sales, finance, and human resource information.

Furthermore, interface 1700 presents a list 1757, 1783 of total assigned accounts 1755 for each account executive 1338, 1348. Each list 1757, 1783 shows customer accounts 1760 with account values 1762 and assignment information 1764. Moreover, interface 1700 shows a comment 1772 text box 1770 for a user 1202 to add comments 1774. The text box 1770 can have a link 1776 for discussed contacts.

FIG. 11 presents an interface 1800 for a stakeholder user 1202 for sales integration 1815 in the sales task force menu 1208. The interface 1800 facilitates action planning 1605 for one or more accounts, as shown in interface 1600. The interface 1800 presents a Gantt chart 1830 of the assimilation actions 1632. The Gantt chart 1830 presents a time period 1835 for each action 1632. The stakeholder 1202 inspects the status 1631 of the action items 1632 to ensure customer satisfaction. The stakeholder 1202 can also contact a number 1842 of other sales task force members 1840, and access a number 1852 of actions 1850, such as managing templates 1855 and profiles 1857.

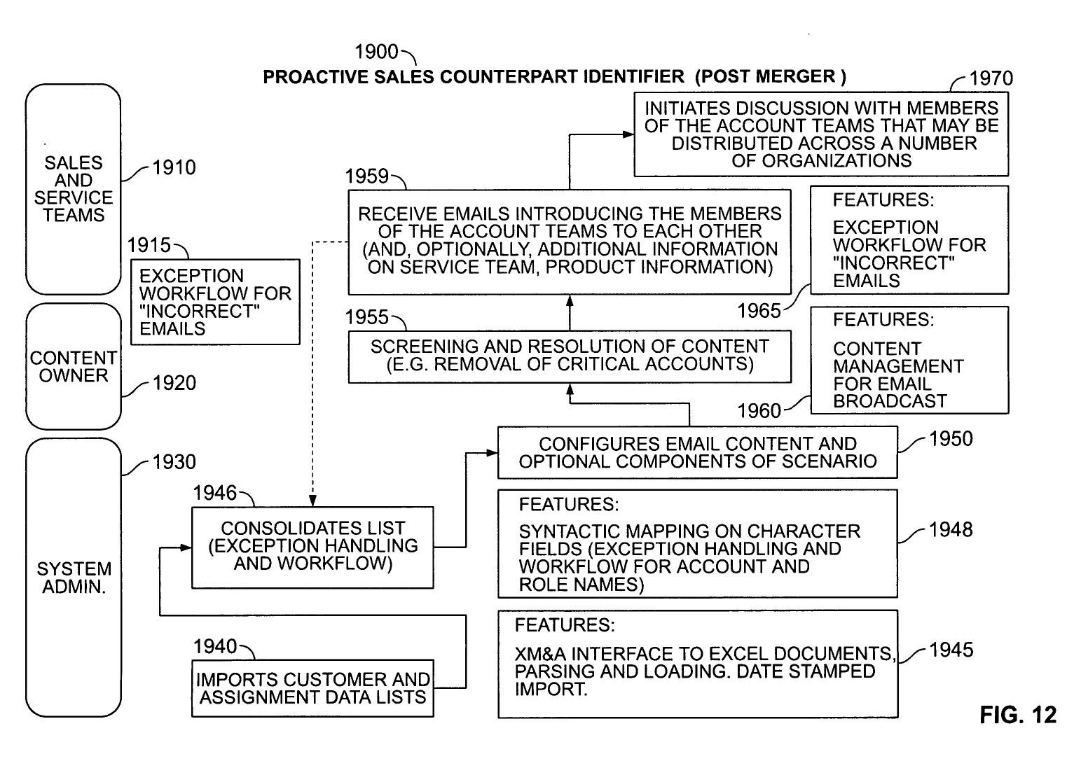

FIG. 12 shows a block diagram of the proactive sales counterpart identifier 1900. A system administration 1930 of one of the merger organizations imports customer and assignment data lists at 1940 and consolidates the list at 1946. Then electronic document (e.g., email) content and optional components of the scenario are configured at 1950. The system administration 1930 can have an object interface 1945 for importing the data, and syntactic mapping on character fields 1948 for configuring and consolidating the data. The owner 1920 of the content can screen the electronic documents at 1955 with a content management tool 1960. The content screening at 1955 can involve removing one or more accounts. The sales and service teams 1910 can receive electronic documents that introduce the account team members of the merger organizations at 1959, and initiate a discussion between the account team members of those merger organizations at 1970. Any incorrect emails 1915 (e.g., exception workflow) can be sent in block 1965 to the system administration 1930 for further consolidation 1946.

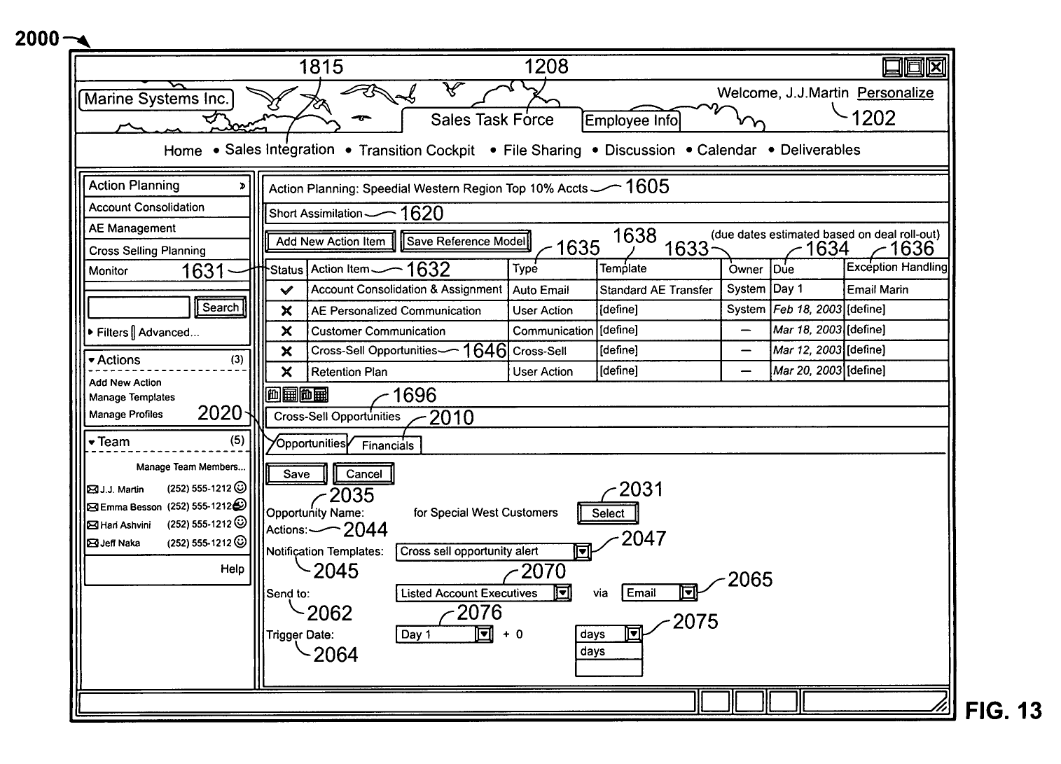

FIG. 13 presents an interface 2000 that facilitates action planning 1605 for one or more accounts. In particular, the interface 2000 includes the action planning items 1632 shown in interface 1600. The interface 2000 includes an action panel to track, manage, and edit cross-selling opportunities 1646. The interface 2000 has a tab 2020 for details of the opportunity 1646, and a tab 2010 with related financial information 2010. The user 1202 can select, generate, and edit an opportunity name 2035 via button 2031. The user 1202 can access a pull down menu 2047 of notification template 2045 to send an email 2062 to a stakeholder via pull down menus 2070, 2065. The action 2044 has an automatic trigger date 2064 to send the email 2065 via pull down menus 2075, 2076.

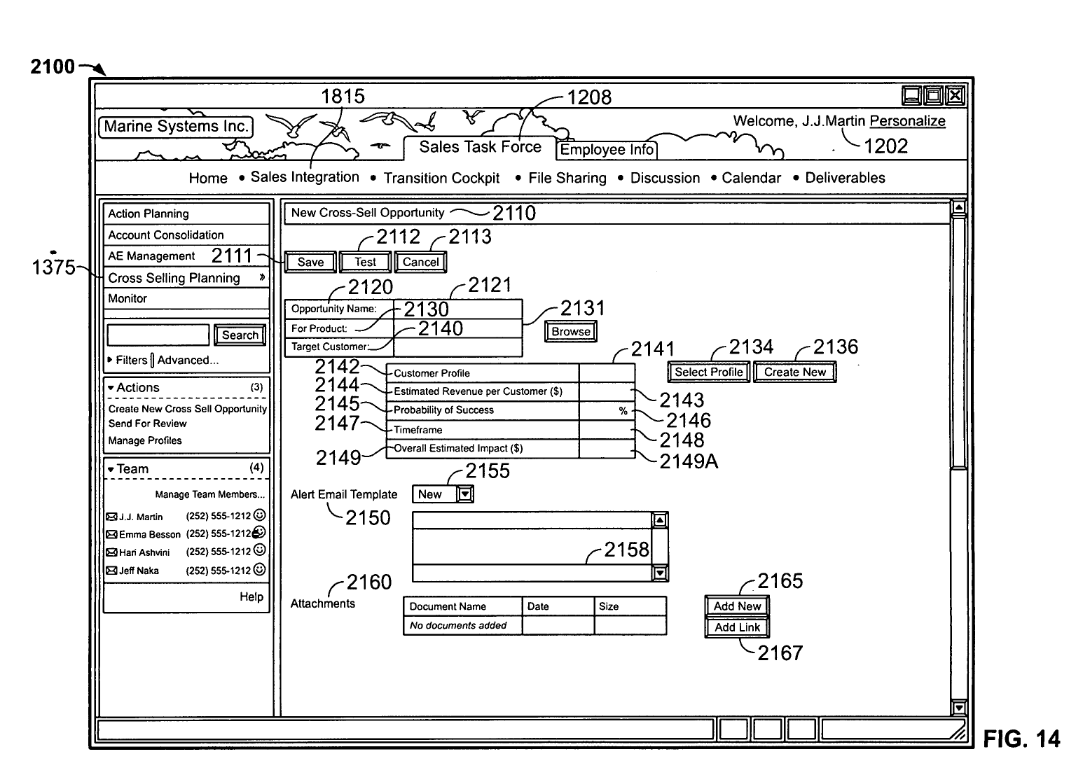

FIG. 14 presents an interface 2100 with a panel for the user 1202 to generate a new cross-selling opportunity 2110. The user 1202 can select the cross-selling planning link 1375 to access the interface 2100. The interface 2100 allows the user 1202 to enter an opportunity name 2120 for a targeted product 2130 via text boxes 2121, 2131. Moreover, the interface 2100 allows the user 1202 to select, edit, or generate a new customer profile 2142 for a target customer 2140 via buttons 2134, 2136 and text box 2141.

Text boxes 2143, 2146, 2148, 2149A in the interface 2100 can allow the user 1202 to enter financial information, such as an estimated revenue per customer 2144, a probability of success 2145, a timeframe 2147, and an overall estimated impact 2149. In addition to a text box 2158, the user 1202 can also access a pull down menu 2155 of alert email templates 2150. Furthermore, the user 1202 can add a new attachment 2160 or an attachment link via buttons 2165, 2167. The user 1202 can save, test, or cancel the cross-selling opportunity 2110 generated in the interface 2100 via buttons 2111, 2112, 2113.

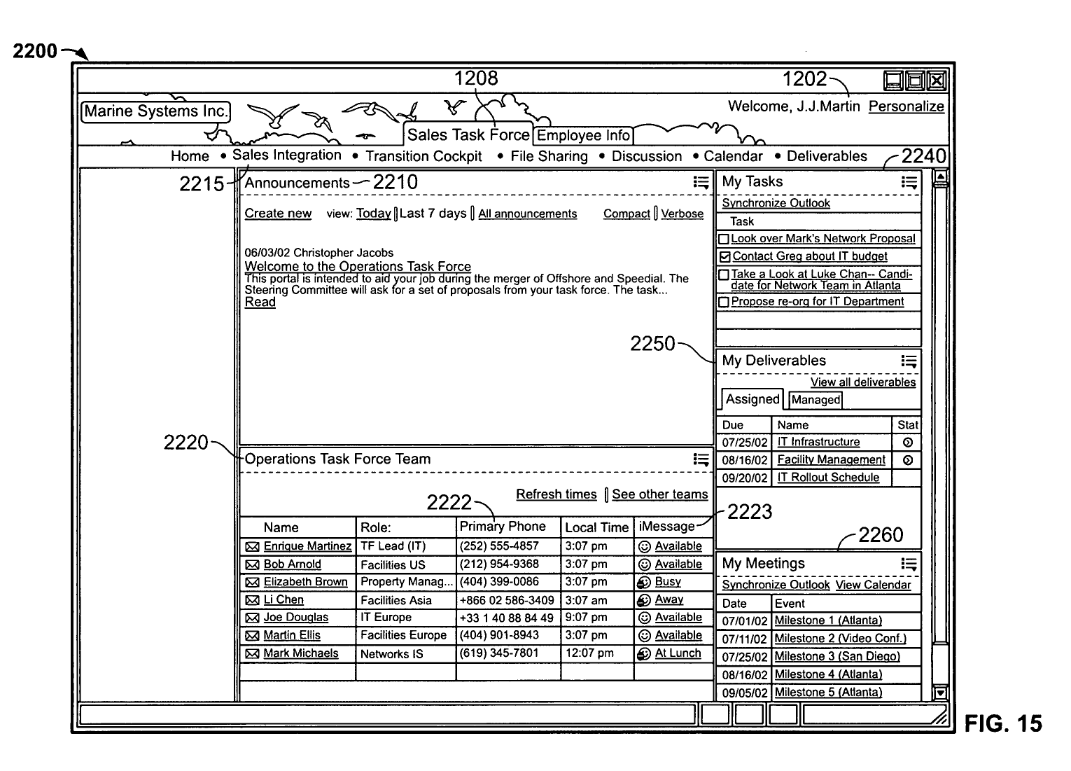

FIG. 15 illustrates an exemplary home page interface 2200 for a stakeholder 1202 in the sales task force 1208. The interface 2200 can be personalized 2202 for the stakeholder 1202 and greet the stakeholder 1202 with an announcement panel 2210. The stakeholder 1202 can view an operations task force team panel 2220, along with contact information 2222 and instant message availability 2223 of team members. The interface 2200 has a feature or utility 2223 that allows a stakeholder to send a private, real-time message to stakeholders on the system. The interface 2200 can have personalized panels for tasks 2240, deliverables 2250, and meetings 2260 and events.

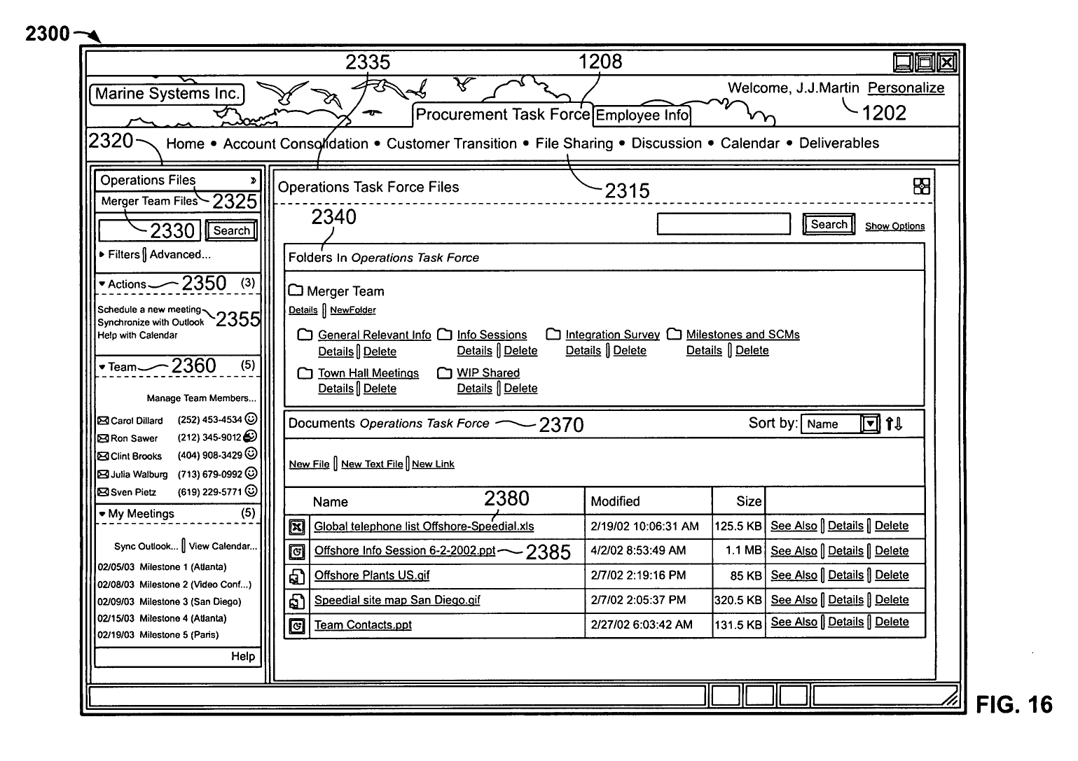

FIG. 16 illustrates an interface 2300 that allows stakeholders from various groups to collaborate and share information during the merger. In particular, interface 2300 is shown for stakeholder 1202 in the sales task force. The sales task force tab 1208 presents the stakeholder 1202 with a menu of views, including a view 2315 for sharing objects with stakeholders in the sales task force. The interface 2300 facilitates collaboration by presenting a view 2335 for the sales task force stakeholders to share folders 2340 and documents 2370 with stakeholders in the operations task force. Some of the shared documents can be external objects 2380, 2385.

The stakeholder 1202 in the sales task force also shares objects with stakeholders in a merger team 2330. Additionally, the stakeholder 1202 views and access other sales task force team members 2360 and initiate merger actions 2350, such as scheduling a new meeting 2355.

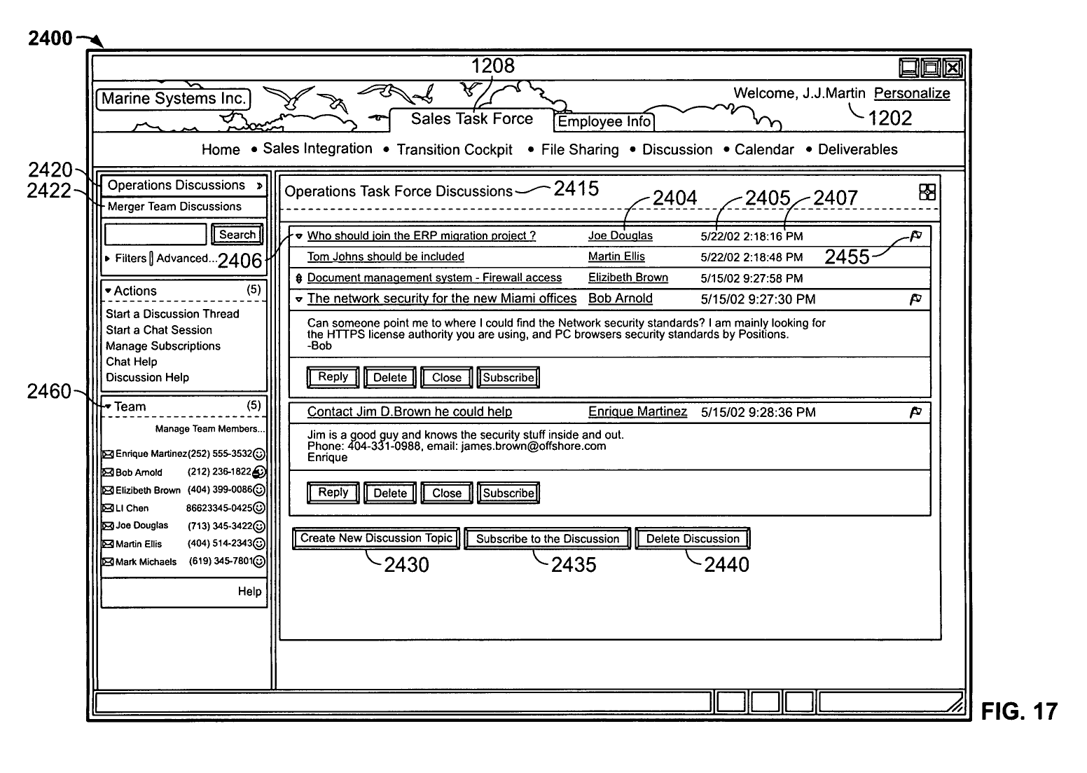

FIG. 17 illustrates an exemplary interface 2400 with a panel 2415 for group discussions. The interface user 1202 can access a merger issue 2406 posted by a member 2404 of a team 2460. The interface 2400 shows the time 2407 and date 2405 of the posting of the issue 2406. A flag or follow-up indicator 2455 signifies that the issue 2406 should be resolved quickly. The team member 1202 can begin a new discussion 2430, subscribe to a discussion 2435, or delete a discussion 2440 from the panel 2415.

The interface 2400 also provides collaborative discussions between members of different merger groups. For example, the user interface 2400 can be accessed by members from a merger team 2422, in addition to members of the operations task force 2420.

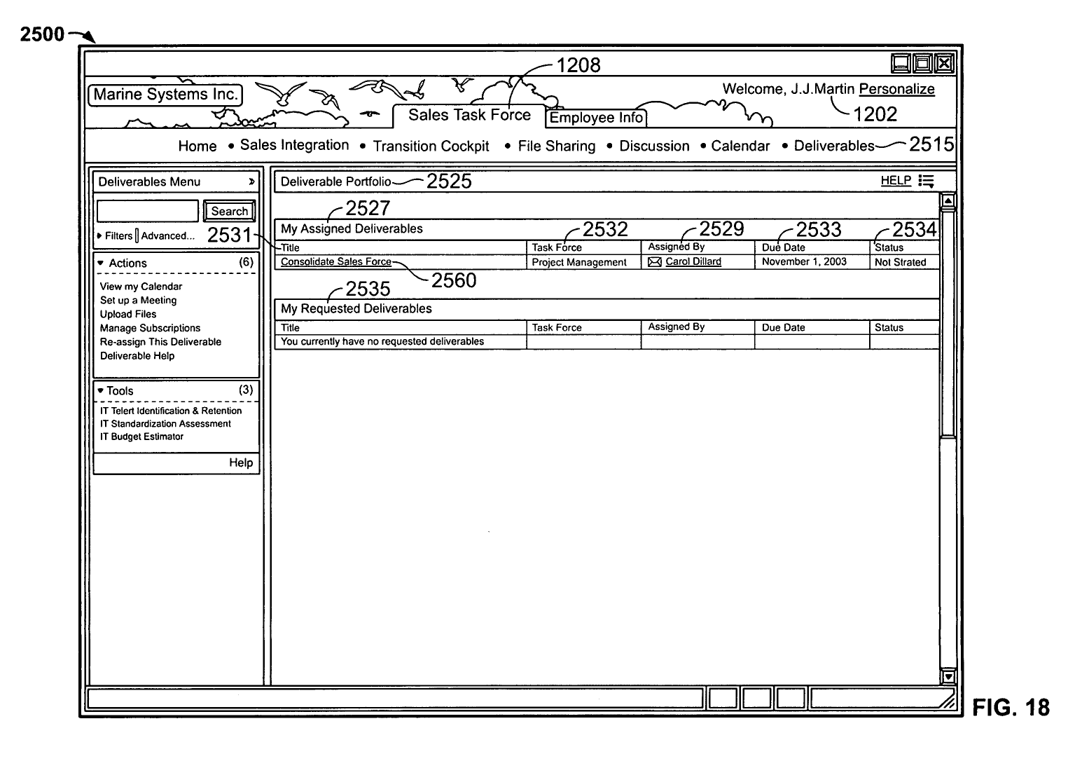

FIG. 18 presents an exemplary interface 2500 with a panel 2525 for sales task force deliverables 2515. The interface 2500 presents the user 1202 with a personalized section 2527 for assigned deliverables and a personalized section 2535 for requested deliverables. Each section 2527, 2535 has a deliverable title 2531, a related task force 2532, a stakeholder assignor 2529, a deadline 2533, and a status 1534. An exemplary deliverable 2560 is a consolidation of the sales force.

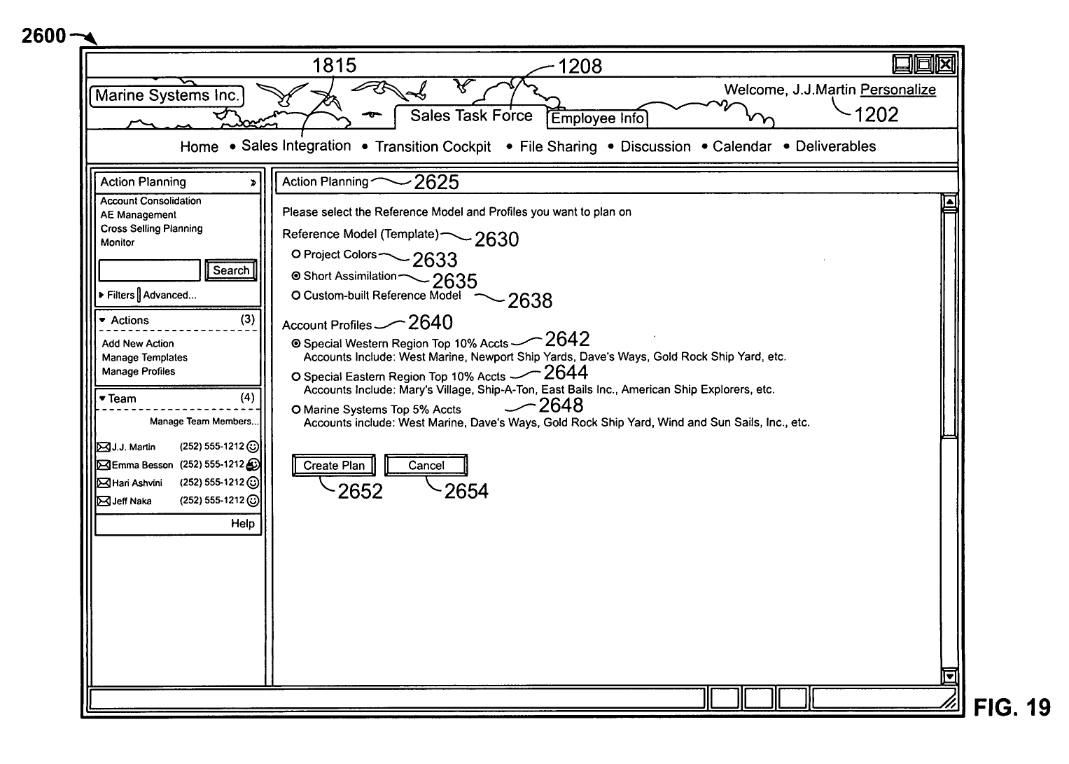

FIG. 19 presents an interface 2600 for stakeholder user 1202 for sales integration 1815 in the sales task force menu 1208. The interface 2600 facilitates action planning 2625 for the sales task force. The user 1202 can select a reference model template 2630 and a pre-defined account profile 2640 for planning. Some exemplary reference model templates 2630 includes a project 2633, an assimilation 2635, and a custom-built reference model 2638. Some exemplary account profiles 2642, 2644, 2648 can also be presented by the interface 2600. This interface 2600 allows the user 1202 to create an action plan via button 1652 or to cancel a selected plan via button 2654.

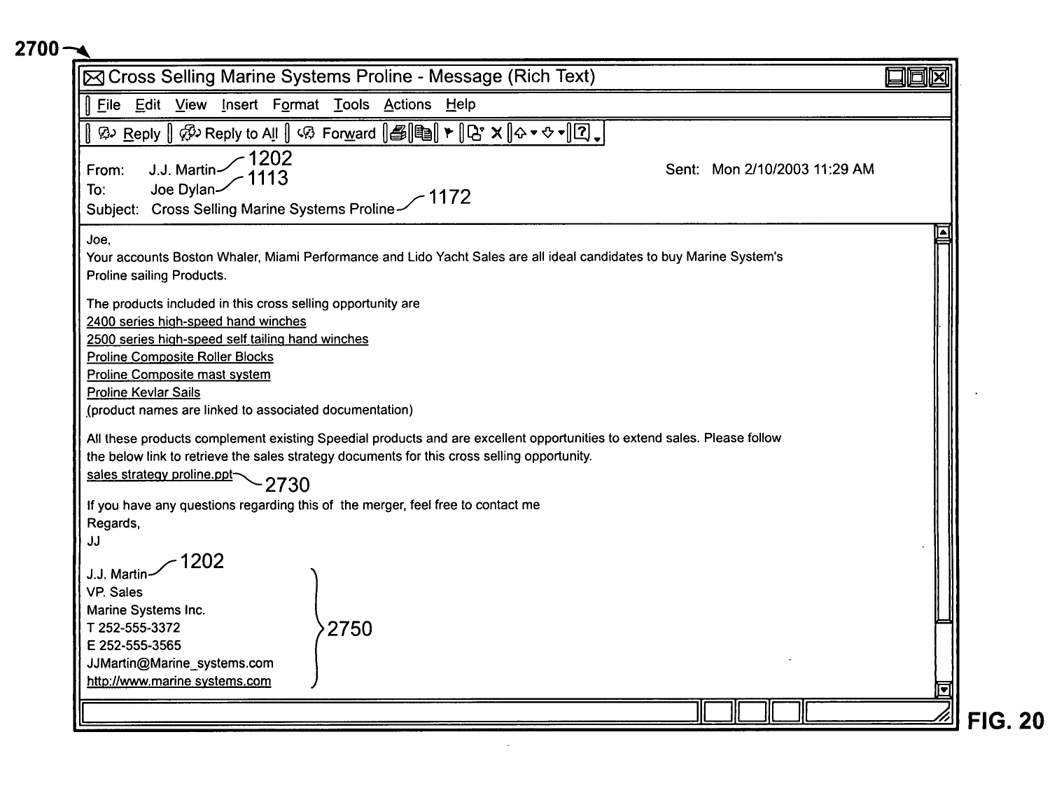

FIG. 20 presents an email 2700 related to a cross-selling opportunity 1172 that can be generated by a sales team leader 1202. The email 2700 can be personalized with predefined information 2750 and sent to the account executive 1113. The email 2700 can be role specific with predetermined content, and be automatically sent to all members servicing a specific account. The email 2700 can include sales-related links 2730 and attachments.

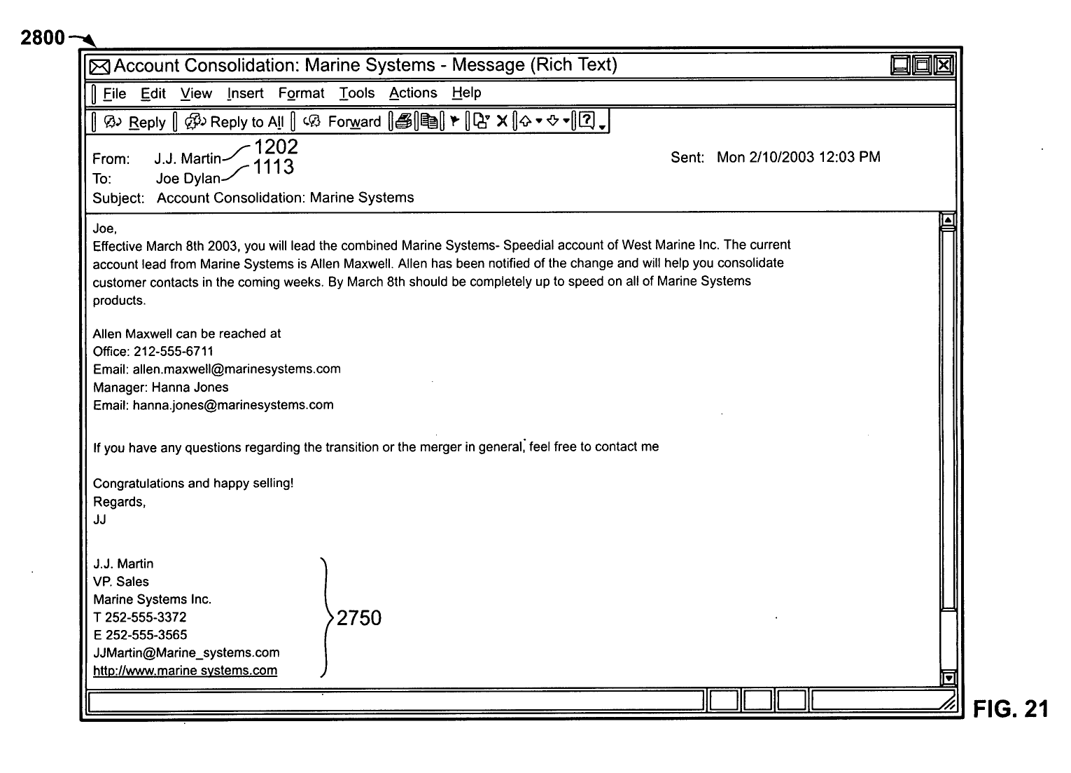

FIG. 21 shows that an email 2800 is generated to notify the account executive 1113 of account consolidation information.

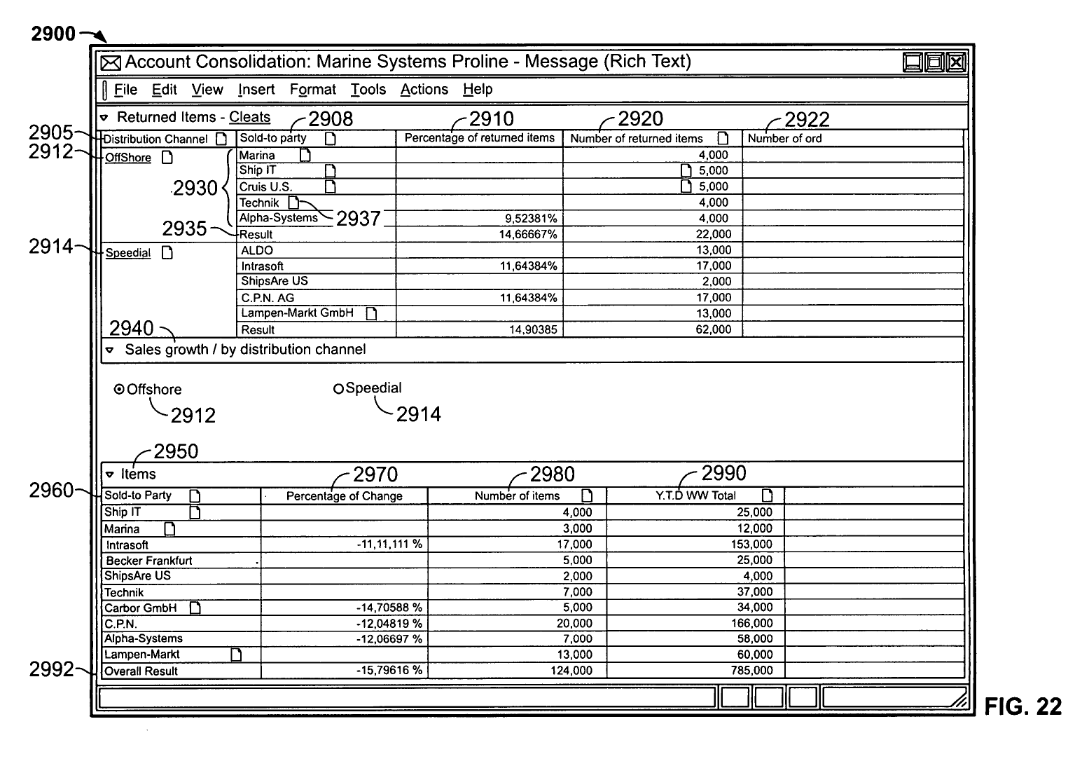

FIG. 22 presents several exemplary panels 2900, 2940, 2950 with sales-related information. Panel 2900 presents a list 2930 of customers for each merger organization 2912, 2914. The panel 2900 can show the list 2930 and a result 2935 based on a distribution channel 2905 and customers 2908. Additionally, a percentage of returned items 2910, a number of returned items 2920, and a number of orders 2922 are presented to the user 1202. One or more linked objects 1937 can also be presented.

Panel 2940 designates sales growth information for one of the merger organizations 2912, 2914 to be shown in panel 2950. The designated panel 2950 shows sales items sold to a customer 2960. The designated panel 2950 also shows a percentage of change 2970, a number of items 2980, a year-to-date world-wide total 2990, and an overall result 2992.

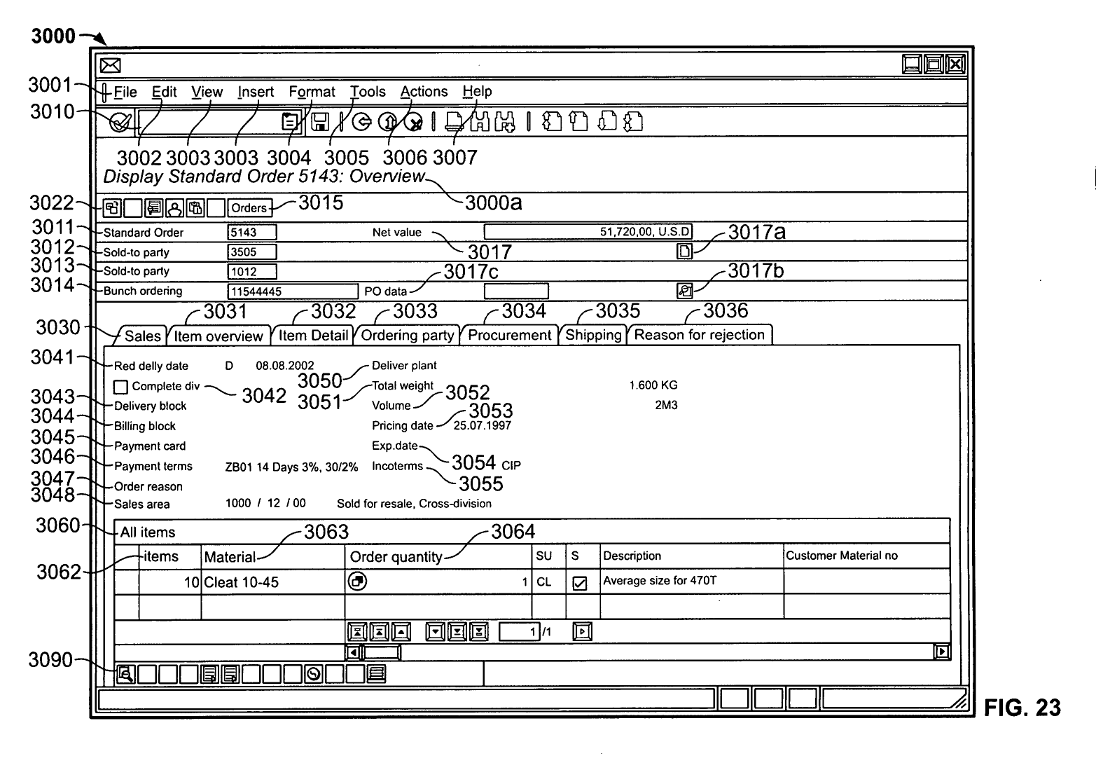

FIG. 23 shows an illustrative interface 3000 for a stakeholder, such as a customer sales representative, to inspect and manage a customer order 3000A. The interface 3000 has a menu to present a sales document 3001, to edit the interface via selector 3002, or to find a particular aspect of sales information via selector 3003. The menu can also have selectors 3004, 3008, 3005, 3006, 3007 for extra features, functions, environmental and system variables, and help resources. The interface 3000 can also have a text box 3010 for searches, and a toolbar 3022 of icon buttons to perform a variety of sales-related functions, such as accessing a table of orders via button 3015.

The interface 3000 allows the stakeholder user 1202 to generate and edit a text or number description for an order 3011, a customer 3012, a shipment target 3013, a purchase order 3014, and a net value 3017. The stakeholder user 1202 views a sales-related document via link 3017A or search for a document via link 3017B.

The interface 3000 has tabbed panels for the order 3000A. Such panels include a sales panel 3030, an item overview panel 3031, an item detail panel 3032, and an ordering party panel 3033. Other panels include panels for procurement 3034, shipping 3035, and sales-related rejections 3036. The sales panel 3030 is shown in interface 3000.

The sales panel 3030 allows a user 1202 to edit a variety of sales items for the order 3000A, such as a requested delivery date 3041, a delivery location 3050, and a shipment weight 3051 and volume 3052. The term “delivery” used in this panel 3030 refers to the goals, targets or process involved in sending a product or service to a customer. The user 1202 can signify that the delivery has been completed at 3042, and edit a name or number for a delivery block 3043 and billing block 3044. A pricing date 3053 can be edited, and a payment card (e.g., credit card) number 3045 and a payment card expiration date 3054 can also be edited by the user 1202. Moreover, the user 1202 can enter payment terms 3046 or credit terms 3055 in the interface, as well as a reason 3047 for the order 3000A and a sales area number 3048.

The sales panel 3030 can have a section 3060 listing all ordered items. The list can show an item 3062, a product material 3063, and an order quantity 3064. Furthermore, the panel 3030 can have a toolbar 3090 to perform a variety of graphical interface functions.

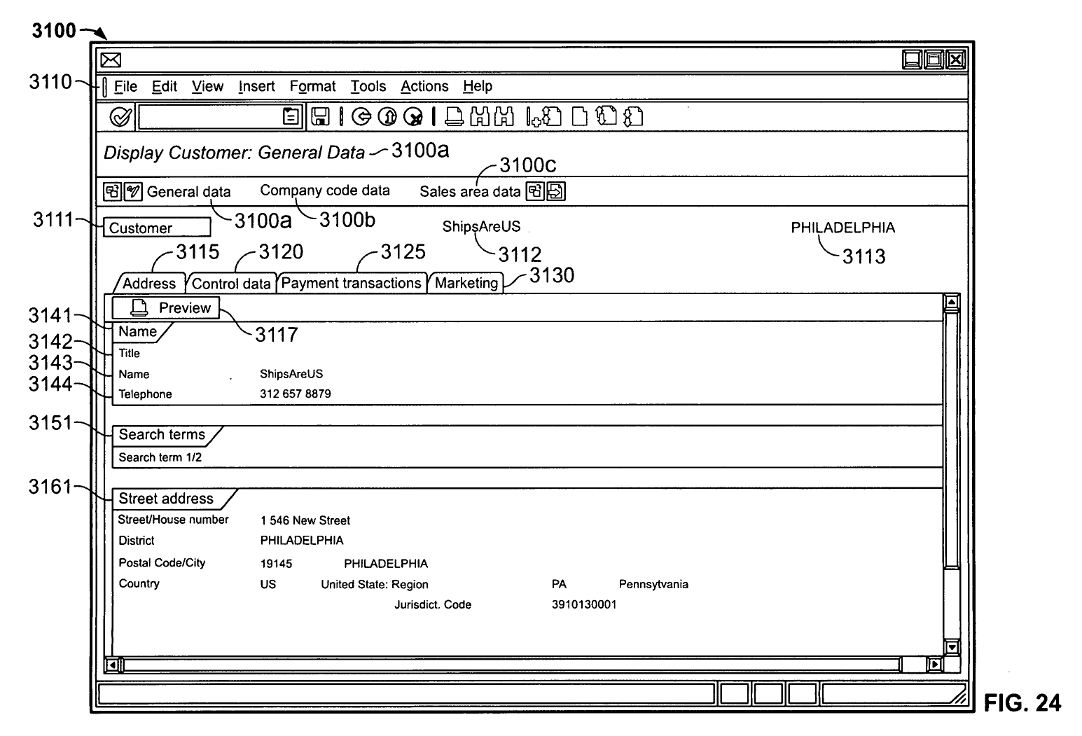

FIG. 24 presents an exemplary interface 3100 to allow user 1202 to generate and edit general data 3100A for a customer. The interface 3100 has a menu 3110 of features and options to manipulate the interface 3100 or to edit and locate customer-related information. The interface 3100 has links to present another interface for company code data 3100B and data 3100C for a sales area. The interface 3100 can also show a customer name 3112, a customer number 3111, and a customer location 3113.

The interface 3100 can include tabbed panels that allow a user to generate and edit customer-related information, such as a customer address 3115 and control data 3120. The interface 3100 also includes a tabbed panel for payment transactions 3125 and a panel for marketing 3130.

The address panel 3115 includes a name panel 3141 to allow a user to generate and edit a title 3142, a name 3143, and a telephone number 3144 for the customer 3112. The address panel 3115 also allows the user to conduct a search 3151 and to edit a street address 3161.

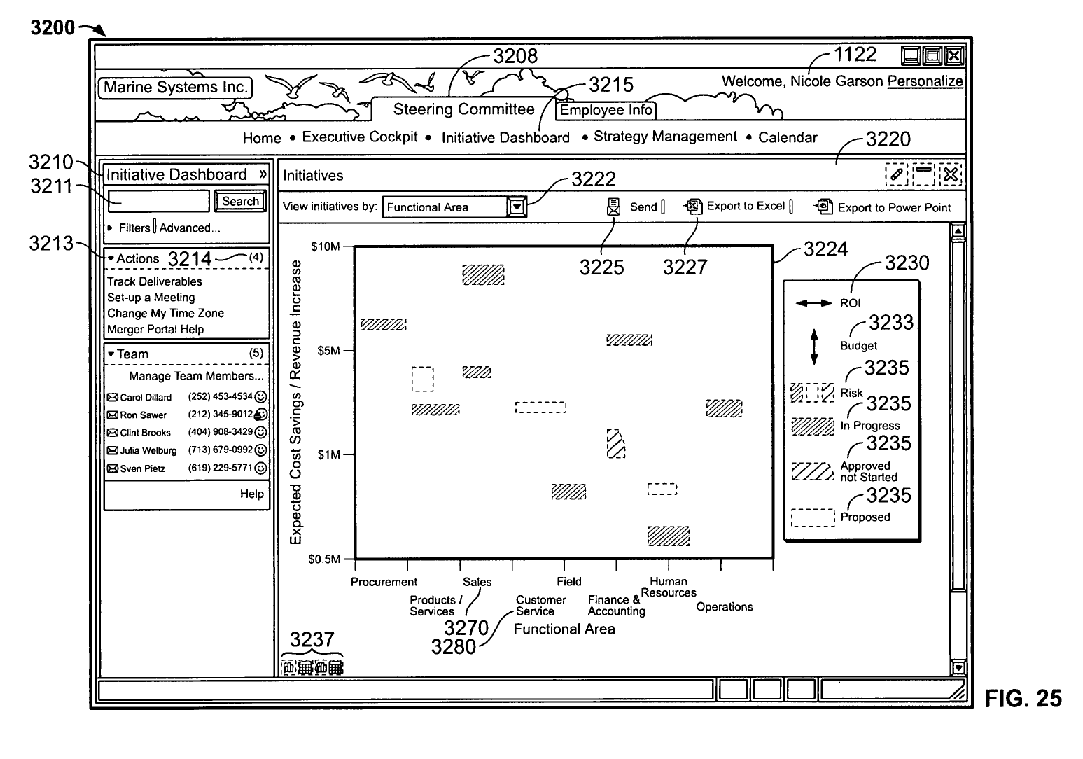

FIG. 25 illustrates an interface 3200 for an initiative dashboard 3215 in a steering committee menu 3208. The initiative panel 3220 allows user 1202 to view a graph 3224 of initiatives. A selector 3222 shows an initiative graph 3224 by functional area, cost savings, revenue increase, or other initiative options. The panel 3220 shows a graph legend 3235 with different types and statuses of merger information. The graph 3224 can also present merger financial information for a functional area, such as a return on investment 3230 or a budget 2233.

A user 1122 can send the initiative information, such as graph 3224, to other stakeholders via icon 3225 or transfer the information to an external software object, such as an Excel spreadsheet 3227 by Microsoft Corporation.

The interface 3200 allows a user to access a graph 3224, a list, or a graph and a list of initiative information via icons 3237. Furthermore, the interface 3200 has a panel 3210 with a text box 3211 to allow the user 1122 to search for items or people, as well as to perform a number 3214 of other actions 3213.

The interface 3200 includes a panel 3240 (FIG. 27) that presents information from the initiative graph 3224 in a list or table format. The panel 3240 presents a functional area 3241 for a number 3239 of initiatives. An initiative risk level 3242, a strategic objective 3243, and an expected cost savings 3244 can also be presented. Additionally, a return on investment 3246 and a cost per headcount 3245 are shown for listed initiatives.

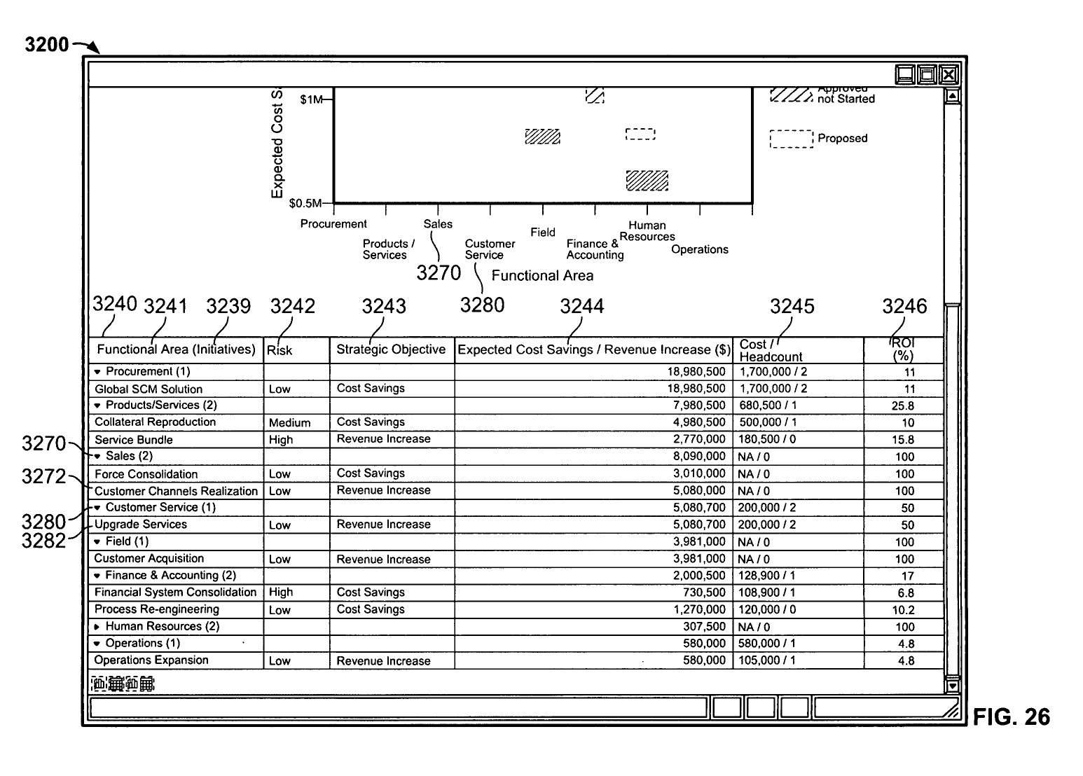

The panel 3240 presents one or more sales and customer services functional areas 3270, 3280 as shown in the graph 3224 in FIG. 26. A sales functional area 3270 includes a realization of customer channels initiative 3272. A customer service functional area 3280 can include upgrading services initiative 3282.

Other embodiments can be within the scope of the following claims.

1. A method comprising:
providing a single logical physically distributed information system across one or more information systems of at least two enterprises, wherein the enterprises are being combined; and
providing a user interface to access the single logical physically distributed information system to execute one or more merger activities of the enterprises, the merger activities comprising a sales-related integration and a management of sales support activities, the sales support activities comprising addressing one or more customer issues for customer retention.

2. The method of claim 1, wherein the merger activities further comprise customer-related communications, the user interface allowing a user to access the single logical physically distributed information system to execute at least one of pre-merger and post-merger activities, wherein the post-merger activities comprise a post-merger assessment and a measurement of one or more achieved synergies.

3. The method of claim 2, wherein the user interface is adapted to the role of the user and a phase of the merger, a security of the user interface is related to the role of the user, the role of the user comprising an executive of one or more sales-related accounts.

4. A method comprising:
providing a user interface adapted to manage one or more cross-selling opportunities for at least one organization involved in a merger with another organization; and
allowing a user to edit one or more cross-selling opportunities presented in the user interface.

5. The method of claim 4 further comprising:
providing information for at least one of the cross-selling opportunities in the user interface; the information comprising a financial information;
providing a notification template in the user interface; and
providing a trigger date in the user interface.

6. A system for managing a merger of at least two organizations comprising a module and a graphical user interface adapted to assist retention of one or more customers of at least one of the organizations.

7. The system of claim 6, wherein the system further comprising a first tool adapted to provide predefined templates for customer-related objects, wherein the customer-related objects comprise customer documents and electronic mailings.

8. The system of claim 7 further comprising a second tool adapted to track one or more customer reactions to merger developments, the merger developments comprising merger-related news and merger-related announcements.

9. The system of claim 8 further comprising a third tool adapted to assist in at least one of an assignment, a mapping, and a transfer of one or more customer accounts, the one or more customer accounts including sales-related accounts.

10. The system of claim 9 wherein the third tool is adapted to facilitate a performance comparison of at least two customer-related personnel for at least one of the merger organizations, the two customer-related personnel including two account executives.

11. A method for managing a merger of at least two organizations comprising providing a module adapted to proactively identify and present on a user interface a sales counterpart in a first merger organization related to a member of a second merger organization.

12. The method of claim 11 further comprising:
producing an electronic mailing, the production of the electronic mailing comprising:
importing lists of data, the lists including a customer list and a customer assignment list;
consolidating the lists of data, the consolidating including syntactic mapping of one or more character fields;
configuring an electronic mailing content; and
screening the electronic mailing content, the content including one or more accounts.

13. The method of claim 12 further comprising:
delivering the electronic mailing content to a sales-related merger member; and
providing an exception workflow for undeliverable electronic mailings.

14. A system for planning a merger of at least two organizations, the system comprising an interface presenting financial information for one or more sales-related and customer-related initiatives of at least one organization, the financial information presented in a list or graph.

15. A system comprising:
sales-related interfaces for a merger of at least two organizations;
user interface components adapted to interact with sales-related interfaces; and
a layer of application logic services, the layer interacting with sales-related interfaces, and the application logic services relating to the merger.
